(19) United States
(12) Patent Application Publication
(10) Pub. No.: US 2021/0192102 A1
(43) Pub. Date: Jun. 24, 2021

(54) Method and Apparatus for Defining a Detailed Route for an Electrical Cable in a Three-Dimensional Model of a Building

(71) Applicant: Katerra, Inc., Menlo Park, CA (US)

(72) Inventors: Sungmin Kim, Morgan Hill, CA (US); Ward Vercruysse, Portola Valley, CA (US); Jumie Yuventi, Sacramento, CA (US); Sarveswara Rao Basa, Hayward, CA (US)

(21) Appl. No.: 16/721,836

(22) Filed: Dec. 19, 2019

(51) Int. Cl. G06F 30/13

(52) U.S. Cl. CPC G06F 30/13

(57) ABSTRACT

Defining a route for a wire between electrical devices in a plan for a three-dimensional (3D) building. The method comprises: receiving an architectural model (AM) of the 3D building; receiving an annotated AM with structural design information, and electrical design information; receiving structural framing data for a plurality of two-dimensional (2D) panels that comprise the 3D building based on the annotated AM, the structural framing data comprising a location for each of a plurality of electrical devices in one or more of the plurality of 2D panels; determining available areas in one or more of the plurality of 2D panels through which a wire can be routed between respective locations of two or more of the plurality of electrical devices; receiving cost-optimized wire routing information for each of the plurality of 2D panels; receiving detailed wire routing rules; defining a route for a wire between respective locations of two or more of the plurality of electrical devices in one or more of the plurality of 2D panels based on: the location for each of a plurality of electrical devices in one or more of the plurality of 2D panels; the determined available areas in one or more of the plurality of 2D panels through which the wire can be routed between respective locations of two or more of the plurality of electrical devices; the cost-optimized wire routing information for each of the plurality of 2D panels; and the detailed wire routing rules.

### TECHNICAL FIELD

Embodiments of the present invention relate to creating a plan for the locations of electrical devices, and cost effective routing of electrical cables there between, in a panelized model of a three-dimensional building.

### BACKGROUND

Building project costing/pricing, material procurement, construction planning, and actual construction/installation is typically done based on CSI specifications and two-dimensional (2D) plans and elevations. These plans and elevations typically do not capture all of the devices (e.g., electrical devices) and interconnections that are needed to actually realize the corresponding system (e.g., an electrical distribution system). These plans typically only capture major infrastructure equipment and devices that at visible/accessible to the end users or as needed to obtain a building permit. This lack of information can result in inefficiencies throughout the building project delivery including: inaccurate pricing since material and work has to be ‘estimated’ from historical benchmarks, over/under ordering of materials particularly those not shown in the drawings, non-ideal crew project management, and longer installation durations since installers need to figure out means and methods on site.

Building Information Modeling (BIM) is meant to help address these problems and improve project delivery efficiencies. However, more simply what is needed are:
1. Design documentation that accurately captures all of the equipment, devices, and interconnections that will represent a 100% constructed system design;
2. Designs that show where exactly all the devices are located in the building relative to other infrastructure, for example, structural structural framing data, etc.;
3. Work instructions associated with installation/interconnections;
4. For prefabrication activities, discrete documentation per assembly capturing all of the above as it relates to the prefab environment.

### BRIEF DESCRIPTION OF THE DRAWINGS

Embodiments are illustrated by way of example, and not by way of limitation, and can be more fully understood with reference to the following detailed description when considered in connection with the figures in which:

FIG. 1 is a flow diagram in accordance with an embodiment of the invention.

FIG. 2 is a flow diagram in accordance with an embodiment of the invention.

FIG. 3 is a flow chart in accordance with one embodiment of the invention.

FIG. 4A is functional block diagram in accordance with one embodiment of the invention.

FIG. 4B is a graphical illustration of a structural frame model 411 in accordance with the embodiment described with respect to FIG. 4A.

FIG. 5A is flow chart in accordance with one embodiment of the invention.

FIG. 5B is an electrical power plan in accordance with one embodiment of the invention.

FIG. 5C is an electrical ceiling plan in accordance with one embodiment of the invention.

FIG. 5D illustrates all structural frames merged in a panel in accordance with one embodiment of the invention.

FIG. 5E illustrates all blockages merged in a panel in accordance with one embodiment of the invention.

FIG. 5F is a Bill of Materials (BOM) generated according to the process depicted in the flowchart in FIG. 5B.

FIG. 5G illustrates mounting locations in terms of a set of coordinates for each electrical device on a panel in the architectural model according to one embodiment of the invention.

FIG. 5H illustrates a shop drawing of electrical devices and their respective locations according to one embodiment of the invention.

FIG. 6 illustrates how output of one embodiment of the invention may be utilized.

FIG. 7 is a model hierarchy of objects according to one embodiment of the invention.

FIG. 8 provide a geometric systems definition in accordance with an embodiment of the invention.

FIG. 9 is pseudocode in accordance with one embodiment of the invention.

FIG. 10 is flow chart of one embodiment of the invention.

FIG. 11 depicts a data model for the floor, walls and ceiling in a three dimensional building in accordance with one embodiment of the invention.

FIG. 12 depicts further aspects of the data model for the floor, walls and ceiling in a three dimensional building in accordance with one embodiment of the invention.

FIG. 13 depicts further aspects of the data model for the floor, walls and ceiling in a three dimensional building in accordance with one embodiment of the invention.

FIG. 14 depicts further aspects of the data model for the floor, walls and ceiling in a three dimensional building in accordance with one embodiment of the invention.

FIG. 15 depicts further aspects of the data model for the floor, walls and ceiling in a three dimensional building in accordance with one embodiment of the invention.

FIG. 16 depicts a data model for a two-dimensional panel in accordance with one embodiment of the invention.

FIG. 17 depicts further aspects of the data model for a two-dimensional panel in accordance with one embodiment of the invention.

FIG. 18 depicts further aspects of the data model for a two-dimensional panel in accordance with one embodiment of the invention.

FIG. 19 depicts further aspects of the data model for a two-dimensional panel in accordance with one embodiment of the invention.

FIG. 20 depicts further aspects of the data model for a two-dimensional panel in accordance with one embodiment of the invention.

FIG. 21 depicts further aspects of the data model for a two-dimensional panel in accordance with one embodiment of the invention.

FIG. 22 depicts further aspects of the data model for a two-dimensional panel in accordance with one embodiment of the invention.

FIG. 23 depicts further aspects of the data model for a two-dimensional panel in accordance with one embodiment of the invention.

FIG. 24 is flow chart in accordance with one embodiment of the invention.

FIG. 25A is flow chart in accordance with one embodiment of the invention.

FIG. 25B is a cable and cable support BOM in accordance with one embodiment of the invention.

FIG. 25C is a shop drawing by structural framing data in accordance with one embodiment of the invention.

FIG. 25D is an electrical installation by cable drawing in accordance with one embodiment of the invention.

FIG. 26 is a graphical depiction of a circuit diagram in in accordance with one embodiment of the invention.

FIG. 27 is a model hierarchy of objects according to one embodiment of the invention.

FIG. 28 shows hole drilling details according to one embodiment of the invention.

FIG. 29 is pseudocode in accordance with one embodiment of the invention.

FIG. 30 illustrates a diagrammatic representation of a machine in the exemplary form of a computer system, in accordance with one embodiment of the invention.

### DETAILED DESCRIPTION

Embodiments of the invention specify a location for each of a plurality of electrical devices in a plan for a three-dimensional (3D) building. The method comprises: receiving an architectural model (AM) of the 3D building; receiving an annotated AM with structural design information, and electrical design information, receiving structural framing data for a plurality of two-dimensional (2D) panels that comprise the 3D building based on the annotated AM; determining available locations in one or more of the plurality of 2D panels at which an electrical device can be located according to the annotated AM and the structural framing data; specifying the location for each of the plurality of electrical devices in one or more of the plurality of 2D panels based on the determined available locations in the one or more 2D panels; and adding to the structural framing data the specified location for each of the plurality of electrical devices in one or more of the plurality of 2D panels.

Additional embodiments of the invention provide for a method for defining a cost-optimized route for a wire through a three-dimensional building. The method comprises: modeling the three-dimensional building as: a two-dimensional array of panels, wherein any two panels in the array of panels are connected panels if a wire can be directly routed from one panel to the other panel, a set of coordinates for each of one or more panels in the array of panels where a wire can enter or exit the panel, and a union of the respective set of coordinates for each of the one or more connected panels in the array of panels where a wire can be routed between the connected panels; and selecting one or more panels in the array through which to route the wire based on the unions of the respective set of coordinates for each of the one or more connected panels in the array of panels.

Additional embodiments of the invention provide for a method for defining a detailed route for a wire between electrical devices in a plan for a three-dimensional (3D) building. The method comprises: receiving an architectural model (AM) of the 3D building; receiving an annotated AM with structural design information, and electrical design information; receiving structural framing data for a plurality of two-dimensional (2D) panels that comprise the 3D building based on the annotated AM, the structural framing data comprising a location for each of a plurality of electrical devices in one or more of the plurality of 2D panels; determining available areas in one or more of the plurality of 2D panels through which a wire can be routed between respective locations of two or more of the plurality of electrical devices; receiving cost-optimized wire routing information for each of the plurality of 2D panels; receiving detailed wire routing rules; defining a route for a wire between respective locations of two or more of the plurality of electrical devices in one or more of the plurality of 2D panels based on: the location for each of a plurality of electrical devices in one or more of the plurality of 2D panels; the determined available areas in one or more of the plurality of 2D panels through which the wire can be routed between respective locations of two or more of the plurality of electrical devices; the cost-optimized wire routing information for each of the plurality of 2D panels; and the detailed wire routing rules.

Each of these above mentioned embodiments is described in further detail below.

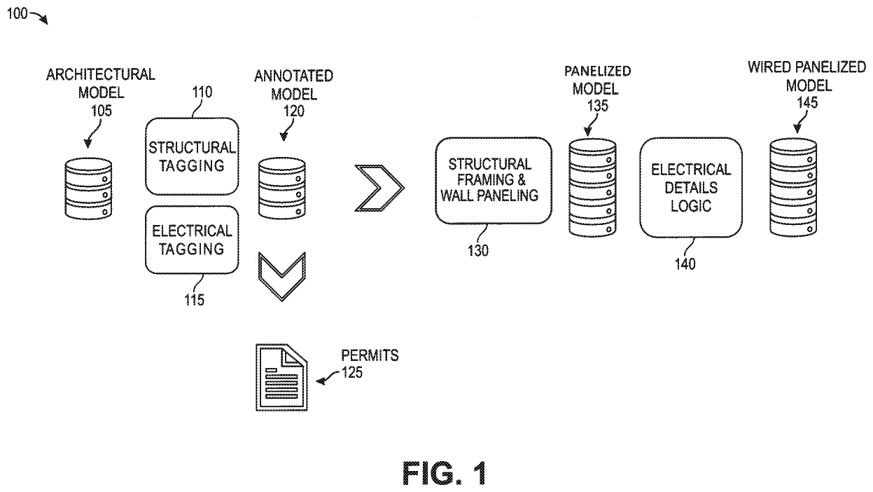

With reference with the flow diagram 100 in FIG. 1, embodiments of the invention receive as input an architectural model 105 for a building project, or building. The architectural model (AM) may be created with building information modeling (BIM) software, such as Autodesk Revit, available from Autodesk. The AM provides floor plans, elevations, sections, and three-dimensional views. In one embodiment, the BIM software may include structural design information, as well as MEP (Mechanical Electrical Plumbing) design information and electrical design information, sufficiently detailed insofar as submitting and obtaining building permits. In another embodiment, the AM does not include the structural design information, MEP (Mechanical Electrical Plumbing) design information and electrical design information, in which case, the AM is annotated with structural design information, or structural tagging 110, and electrical design information, or electrical tagging 115, thereby creating an annotated AM 120. In another embodiment, the AM includes high level structural design information, MEP (Mechanical Electrical Plumbing) design information and electrical design information, but not sufficient information for the purpose of submitting and obtaining building permits 125, in which case, the AM is annotated with further detail regarding the structural design information (structural tagging 110), and electrical design information (electrical tagging 115), and an annotated AM 120 is created. The AM 105 or the annotated AM 120, as the case may be, is submitted to appropriate government authorities/agencies to obtain the necessary permits to begin construction.

According to an embodiment, the AM as augmented with the detail regarding the structural design information and electrical design information, whether the AM 105, or the annotated AM 120, is further augmented at 130 to include structural framing data and wall paneling information for the three-dimensional building, and output as a panelized model 135 of the building.

Embodiments of the invention include electrical routing logic to receive the panelized model 135 and add at 140 specific electrical details to the model, including the location of electrical devices, and routing information for electrical cables connecting the electrical devices, and output a wired panelized model 145 of the building. In one embodiment, the wired panelized model is fed back to the BIM software, where a user can view all the additional details of the building project.

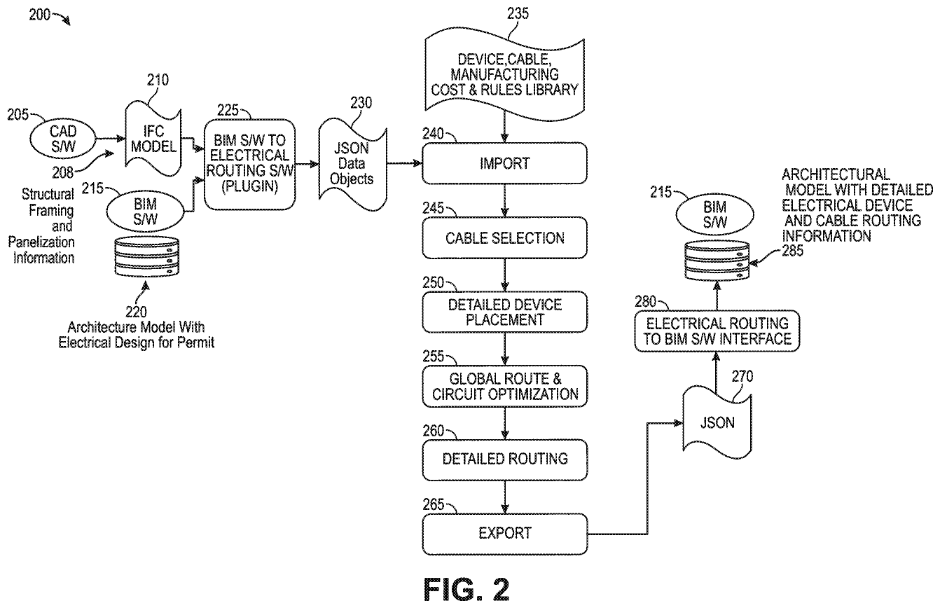

With reference to a more detailed flow diagram in FIG. 2, embodiments of the invention 200 receive as input an architectural model 220 for a building project, which may comprise one or more buildings. The architectural model (AM) may be created and/or modified with building information modeling (BIM) software 215, such as Autodesk Revit, available from Autodesk. In this embodiment, the AM includes electrical design information, but structural design information is not present. Computer aided design (CAD) software 205, such as hsbcad software, available from hsbcad, Drongen, Belgium, receives structural framing data and, optionally, panelization information 208 and outputs a structural framing data and optional panelization data model 210 of such. In one embodiment the data model 210 is formatted according to the Industry Foundation Classes (IFC) data model. (The Industry Foundation Classes (IFC) data model is intended to describe architectural, building and construction industry data. IFC is a platform neutral, open file format specification that is not controlled by a single vendor or group of vendors. It is an object-based file format with a data model developed by buildingSMART (formerly the International Alliance for Interoperability, IAI) to facilitate interoperability in the architecture, engineering and construction (AEC) industry, and is a commonly used collaboration format in Building information modeling (BIM) based projects. The IFC model specification is open and available. It is registered by ISO and is an official International Standard ISO 16739-1:2018).

According to this embodiment, a BIM S/W to electrical routing software module, or BIM plug-in, 225, receives structural framing data and, optionally, panelization information from data model 210, and the AM 220, and produces data objects corresponding to components in the AM. In one embodiment, the data objects are formatted as JSON data objects 230, and include all the information the electrical details logic needs about the architectural model (AM) and structural framing data and, optionally, panelization information.

Electrical details logic 140 in FIG. 1 includes one or more of the functional blocks 240-265 in FIG. 2, as discussed further below. Embodiments of the invention receive, or import, at logic block 240 the JSON objects 230, including the structural framing data and, optionally, panelization information from data model 210, and further import at logic block 240 from one or more libraries 235 information about electrical devices, electrical cables, manufacturing costs, structural design rules, electrical code rules (e.g., National Electric Code (NEC) based rules; the NEC is a regionally adoptable standard for the safe installation of electrical wiring and equipment in the United States), and user rules. Logic blocks 240-265 then add specific electrical details to the model, including: the correct or appropriately sized electrical cables via electrical cable selection logic block 245; the specific location of electrical devices via logic block 250 (wherein the location of one or more electrical devices specified in the augmented AM imported into the electrical routing logic may be moved or adjusted, for example, for ease and cost of installation); and, routing information for the selected electrical cables to connect the electrical devices into various electrical circuits via global routing and circuit optimization logic block 255 and detailed routing logic block 260. Embodiments then output via logic block 265 a wired panelized model of the building in the form of JSON objects 270. In one embodiment, a logic block 280 communicates back to the BIM software 215 the wired panelized model of the building, and the BIM software updates the architectural model 285 accordingly to include specific electrical device location information and electrical cable routing information for connecting the electrical devices. In one embodiment, logic block 280 is the BIM plug-in 225. In other embodiments, the logic block communicates with CAD software 205, which, in turn, updates IFC model 210 with the electrical details, when then may be passed on to the BIM 215 or BIM plug-in 225, and added to the AM 220.

According to the embodiments, as further discussed below, global routing and circuit optimization logic block 255 determines, generally, through which panels to route the electrical cables, and within each panel, where to route electrical cables, and where to drill or use existing holes through which beams and studs of the panel, to route the electrical cables. Detailed routing logic block 260 then determines exact electrical cable routes, and means for routing and affixing the cables to beams and studs within the panels using, e.g., staples, zip ties, etc., and exactly where on the beams or studs to affix the cables.

### Location for an Electrical Device in a Three-Dimensional Model of a Building

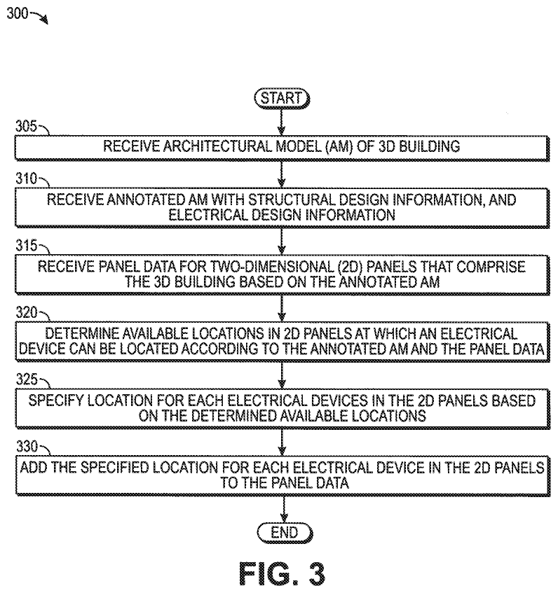

As discussed above, certain of the logic blocks illustrated in FIG. 2, in accordance with embodiments of the invention, work together to specify a location for each of a plurality of electrical devices in an architectural model of a three-dimensional (3D) building project. With reference to FIG. 3, the method 300 comprises logic 305 for receiving an architectural model (AM) of a 3D building, and/or logic 310 for receiving an annotated AM that includes further structural design and electrical design information, logic 315 for receiving structural framing data for a plurality of two-dimensional (2D) panels that comprise the 3D building based on the annotated AM. Logic 320 (corresponding to logic block 250 in FIG. 2) then determines available locations in one or more of the plurality of 2D panels at which an electrical device can be located according to the annotated AM and the structural framing data, and logic 325 specifies the location for each of the plurality of electrical devices in one or more of the plurality of 2D panels based on the determined available locations in the one or more 2D panels. Finally, logic 330 adds to the structural framing data the specified location for each of the plurality of electrical devices in one or more of the plurality of 2D panels.

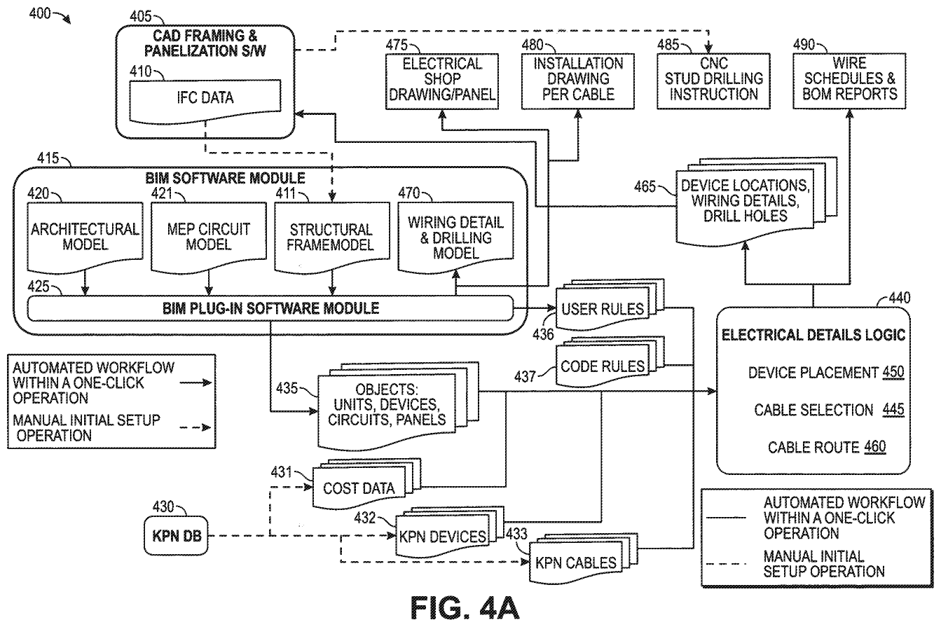

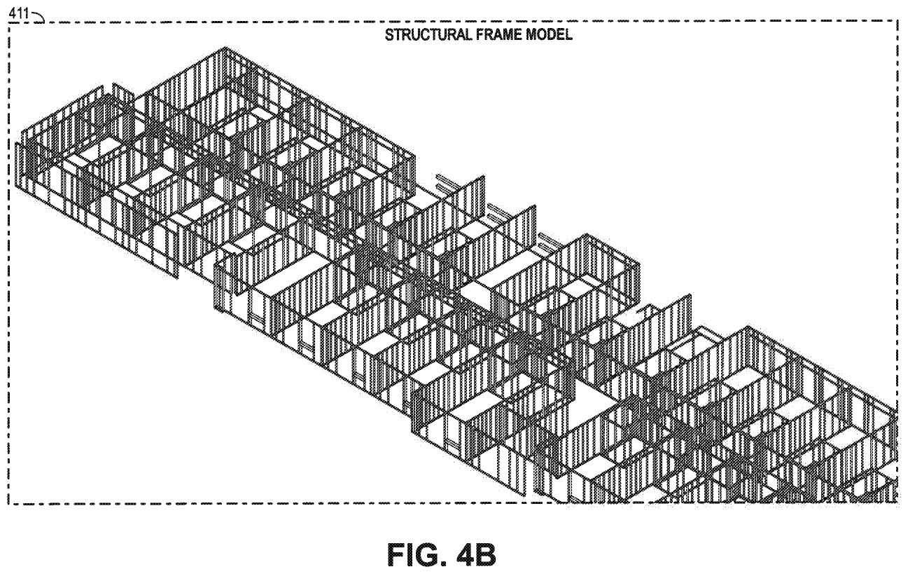

With reference to the functional block diagram in FIG. 4A, an embodiment of the invention 400 includes electrical details logic 440 which, among other things, includes electrical device placement logic 450 to specify a location, or place, for each of a plurality of electrical devices in an architectural model for a three-dimensional (3D) building, electrical cable selection logic block 445 to select the correct or appropriately sized electrical cables, and cable route logic 460 to determine exact electrical cable routes, and means for routing and affixing the cables to beams and studs within the panels using, e.g., staples, zip ties, etc., and exactly where on the beams or studs to affix the cables. Embodiment 400 receive as input an architectural model 420 for a building project comprising one or more buildings. The architectural model (AM) may be created with building information modeling (BIM) software 415. In the illustrated embodiment, the BIM software does not include electrical design information. Such information is input as part of the MEP Circuit Model 421. BIM plug-in software 425 receives the MEP Circuit Model 421 as input and augments the AM to include this information. Likewise, structural design information is not present in the AM 420. Computer aided design (CAD) structural framing data and optional panelization software 405 generates an IFC data model 410 of structural framing data and, optionally, panelization information. In one embodiment, the IFC data model 410 of the structural framing data and optional panelization data is not compatible with the BIM software and corresponding database, so the IFC data model 410 is converted into a structural frame model 411 that is compatible with the BIM software and corresponding database, and then added to the AM via the BIM plug-in software 425. In another embodiment, the IFC data model is compatible with the BIM software and database and so is input or incorporated directly into the database by BIM plug-in software 425 to augment the AM to include the structural design information. FIG. 4B illustrates one embodiment of structural frame model 411.

The BIM plug-in software 425 receives the architectural model 420, the structural framing data and optional panelization information in structural frame Model 411, and the electrical design details in MEP Circuit Model 421, and generates data objects 435, such as data objects for electrical units, electrical devices, electrical circuits, and wall panels. These data objects are input to and used by the electrical details logic 440, in particular, the electrical device placement logic 450, to locate or place the electrical devices within the panels. Examples of electrical device information objects include:

electrical device categories, such as: “LOAD CENTER”, “RECEPTACLE”, “SWITCH”, “LIGHTING”, “LOWVOLTAGE”, “JUNCTION”, “OTHER”;

electrical device mount types, such as: “WALL”, “CEILING”, “FLOOR”, “WALL_SURFACE”, “OFF_WALL”;

electrical device dimensions; and

cable access locations for each device.

Embodiments of the invention receive at electrical details logic block 440 the data objects 435, including the structural frame model 411, and further from one or more libraries, user control rules 436 and electrical code (e.g., NEC) rules 437. User control rules are control parameters that a user can input to control the electrical device placement logic 450 in terms of exactly where to place electrical devices. For example, user rules might include allowable locations for drilling holes in beams or studs, and the maximum diameter and length of any such holes.

A known product number (KPN) database 430 provides corresponding part numbers for each object 435, whether the KPN for an electrical device 432, or the KPN for an electrical cable 433, and costs data 431 for each device or cable, to the electrical details logic 440.

Electrical device placement logic 450 generates the specific location of electrical devices based on the user rules and code rules, and outputs the specific electrical device locations at 465. This information, in turn, is provided to CAD structural framing data and optional panelization software 405, wherein a CAD user can modify the Structural frame IFC data 410 to take into consideration new details regarding the actual placement, or location, of the electrical devices. The Structural frame IFC data 410, in turn, may be converted to Structural frame Model 411 data and added to the BIM by BIM plug-in 425, which updates the wiring detail and drilling model 470 for the BIM accordingly.

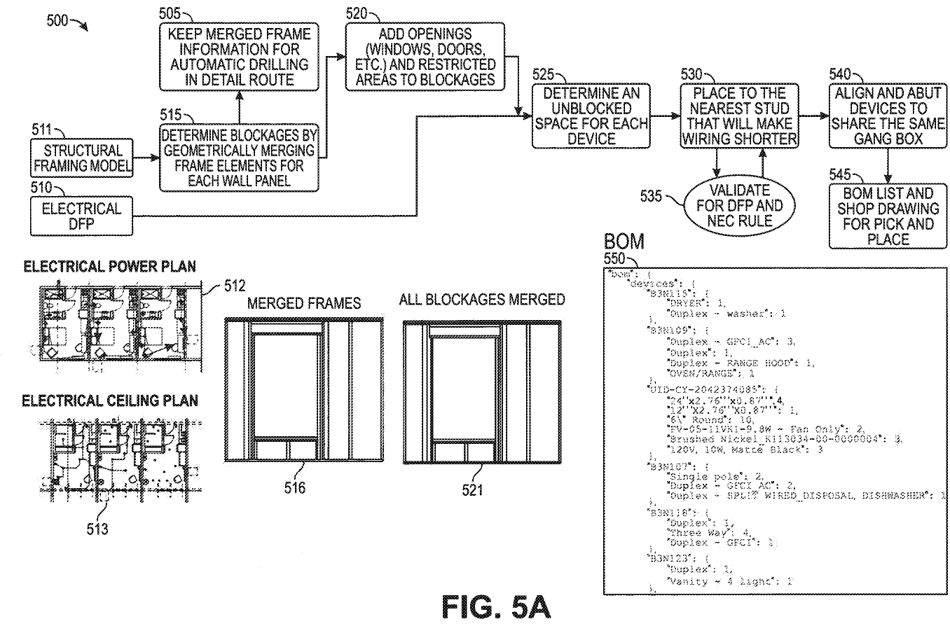

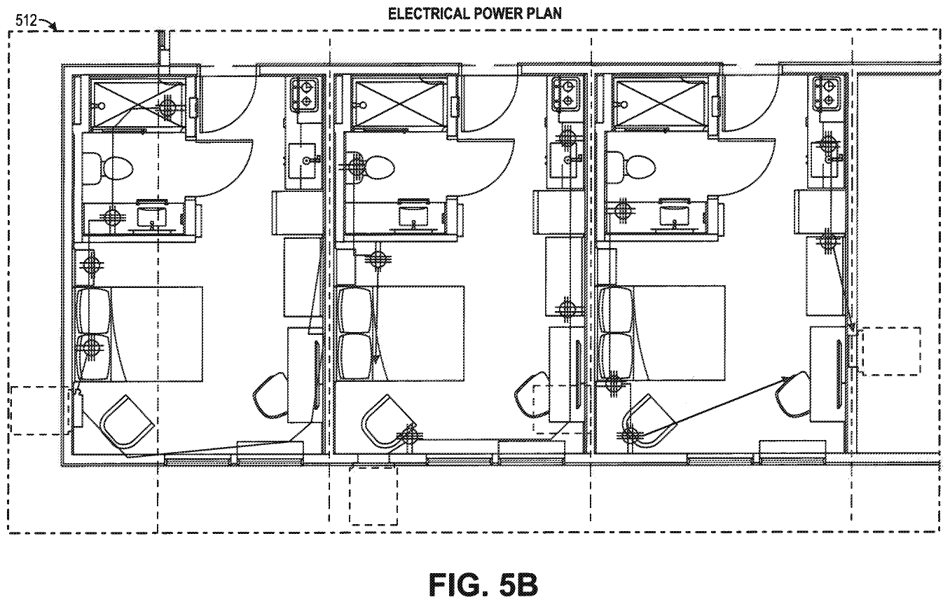

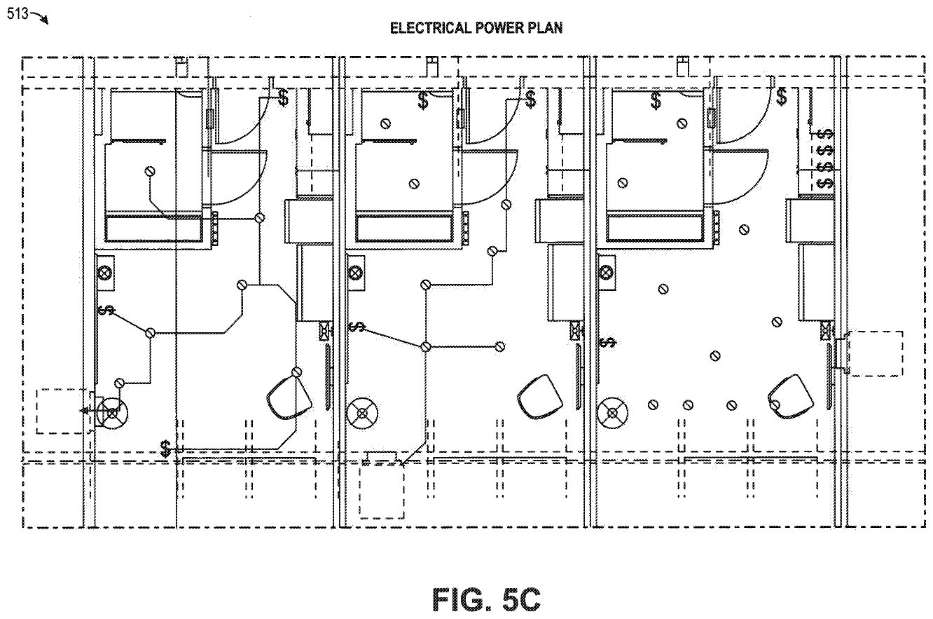

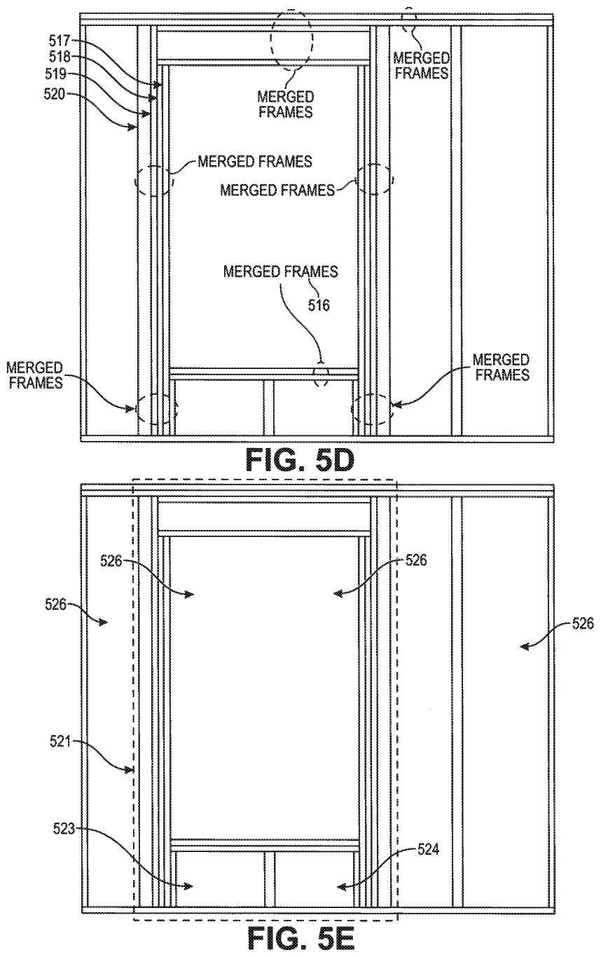

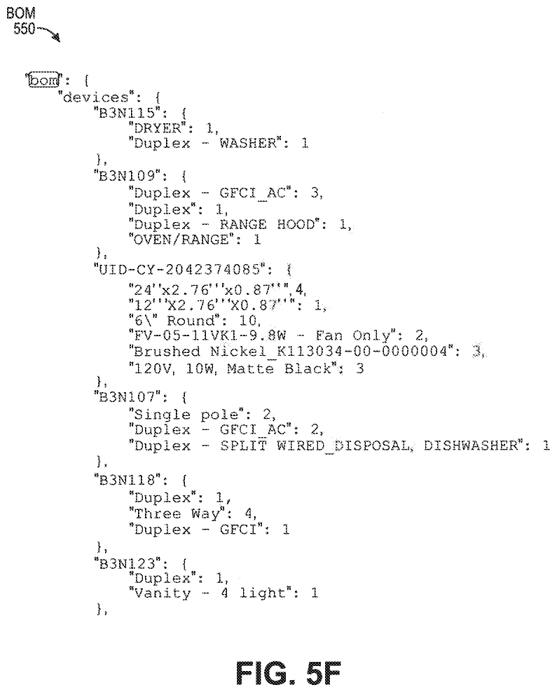

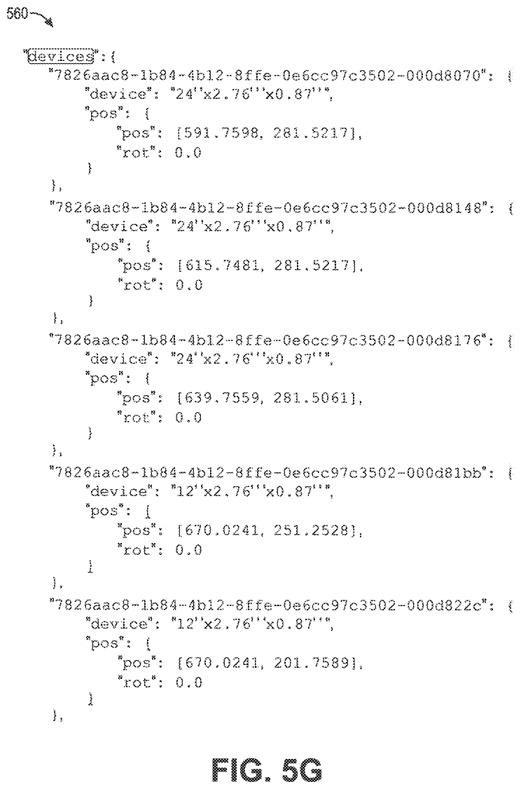

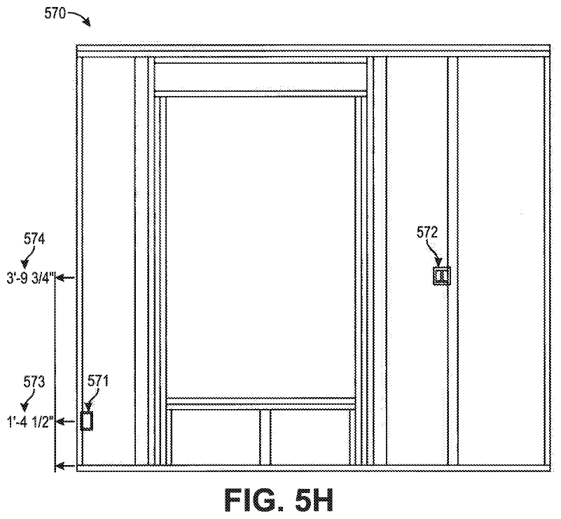

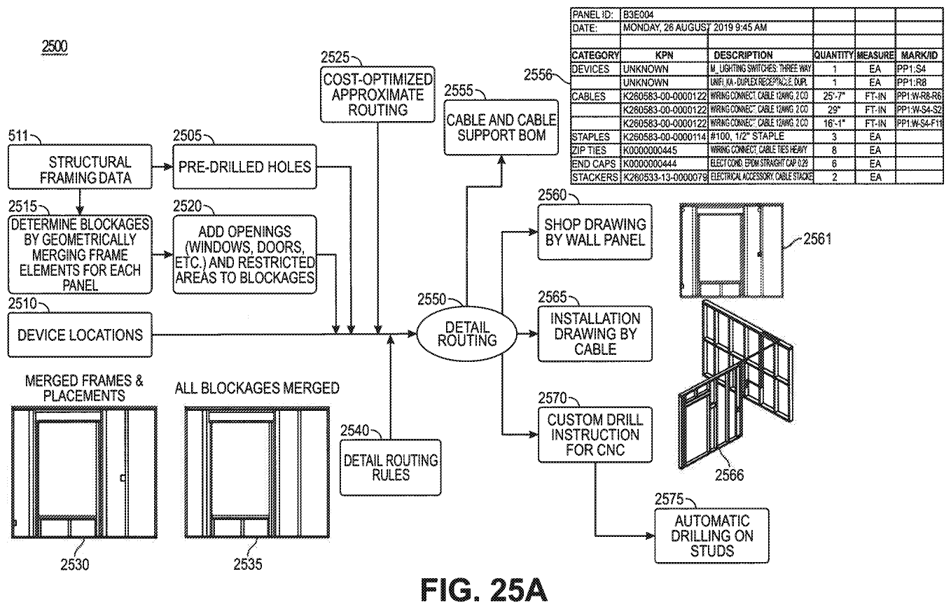

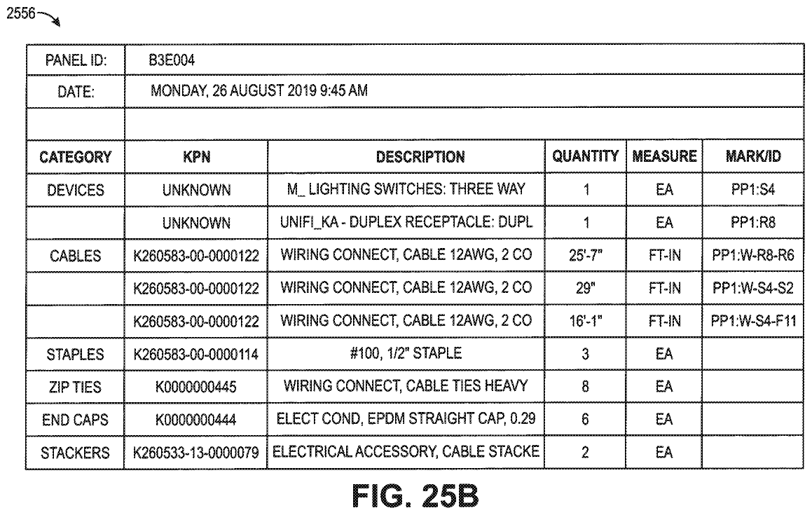

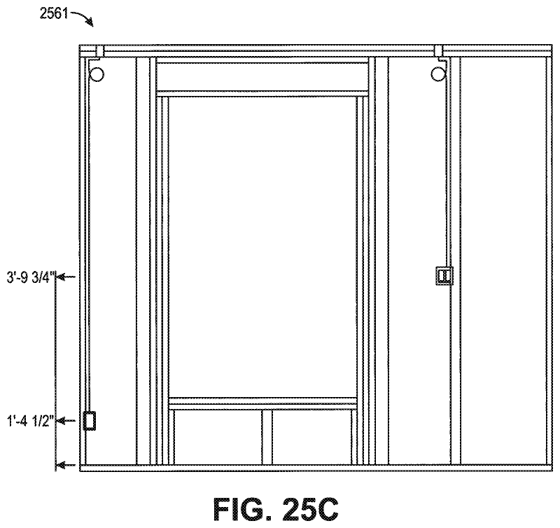

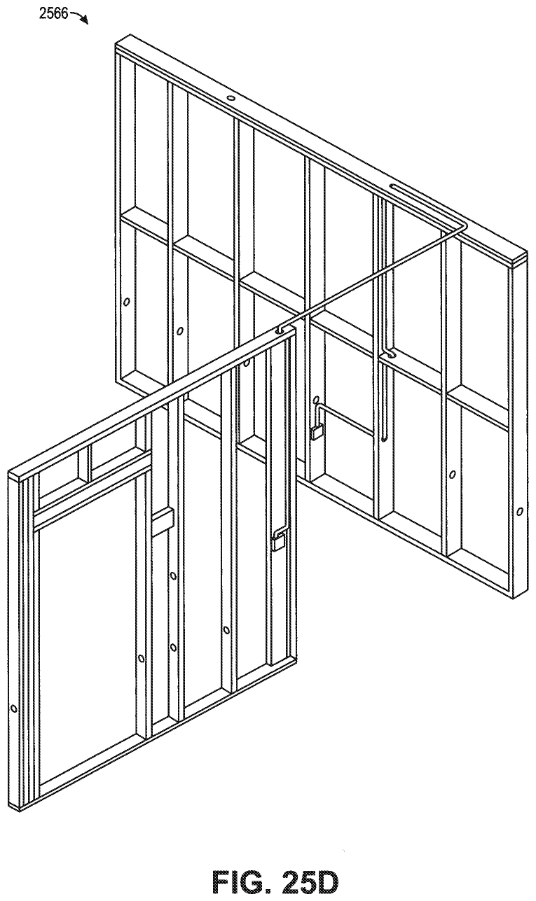

With reference to FIG. 5A, one embodiment 500 for electrical device placement logic 450 is described as follows. The process receives structural framing data model 511, and electrical design information 510, wherein the electrical design information is at least as detailed as needed for submitting and obtaining electrical permits (Electrical Design for Permit—Electrical DFP). Examples of electrical design information are illustrated at 512 and 513 in FIGS. 5B and 5C, respectively. Logic 515 identifies individual structural frame blockages, e.g., structural framing data members of panels, such as beams, studs, plates, where an electrical device cannot be placed, and merges adjacent structural frame blockages 516. For example, with reference to FIG. 5D, respective abutting vertical studs 517, 518, 519, and 520 are, individually, a structural frame blockage in the sense that an electrical device cannot be placed over such a stud. Embodiments of the invention group, or geometrically merge, these individual structural frame blockages to represent the structural frame blockages as a single structural frame blockage 516 for the purpose of locating an electrical device. This information is also saved at logic 505 and provided to similar logic 2505 in the electrical cable routing logic 460 discussed further herein with reference to FIGS. 4A and 25A.

With reference to FIGS. 5A and 5E, logic 520 identifies additional areas, such as openings 522 (windows, doors), and restricted areas 523, 524 where an electrical device cannot, should not, or preferably should not, be located, such as under a window, and merges adjacent areas as single area blockage. Area blockages, in turn, as the case may be, are merged with the adjacent merged structural frame blockages. For example, with reference to FIG. 5E, structural frame blockages and area blockage are merged into one blockage 521. An electrical device will not be placed over or within blockage 521. Embodiments of the invention group, or geometrically merge, the structural frame blockages and area blockages to represent the blockages as a single blockage 521 for the purpose of locating an electrical device.

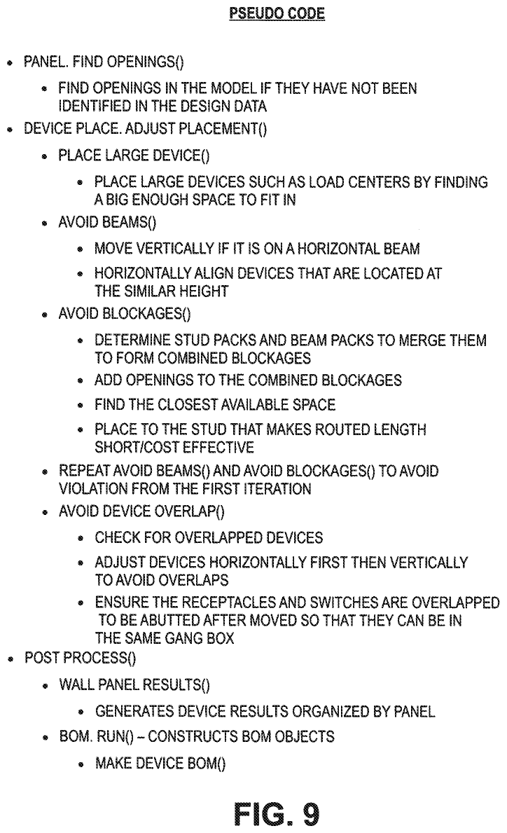

With further reference to FIGS. 5A and 5E, logic 525 identifies unblocked, or open spaces 526 in which an electrical device can be located. In one embodiment, the logic identifies a particular space or portion thereof in which to locate each electrical device. Logic 530 then determines, based on the structural framing data and optional panelization information, the blockages, and the unblocked spaces, the nearest structural framing data member, e.g., stud, to which to mount each electrical device. In particular, according to embodiments, a box is mounted to a nearest structural framing member. One or more electrical devices, such as a receptacle, switch, a lighting device, is installed in the box. In other instances, the electrical device is a box of some sort itself, such as a load center or junction box. The mounting location may be specified in terms of a set of coordinates 560 for each electrical device on a panel in the architectural model, as illustrated in FIG. 5G. In one embodiment, the logic 530 determines the nearest stud, and location thereof, for each electrical device taking into consideration the shortest and/or most cost effective route for the electrical wire or cable that connects the electrical device to an electrical circuit, and further taking into consideration user rules in one embodiment. In one embodiment, validation logic 535 confirms the selected location of the nearest stud conforms to the appropriate permits and code rules. According to one embodiment, logic 540 aligns, abuts, groups electrical devices, such as switches and/or electrical outlets (wall plugs) to be adjacent one another, or share the same location, e.g., mounted in the same “gang box” that houses two or more electrical devices (e.g., a combination of an outlet/switch, or two or more outlets/switches in one location). FIG. 9 provides example pseudocode for the logic described with reference to FIG. 5A.

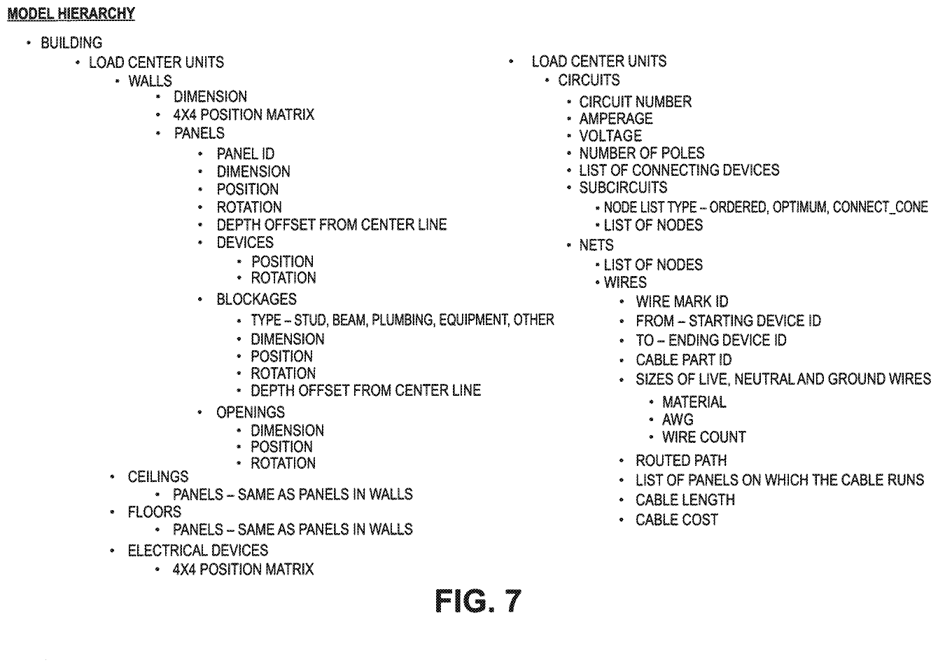

The process performed by logic blocks 515-540 provide for updating the structural framing data model 511 with significant details regarding the model. FIG. 7 illustrates a hierarchy for the model, and where within the hierarchy the information generated by logic blocks 515-540 is located, e.g., location of blockages and openings in panels for walls, ceilings, floors, and location of devices.

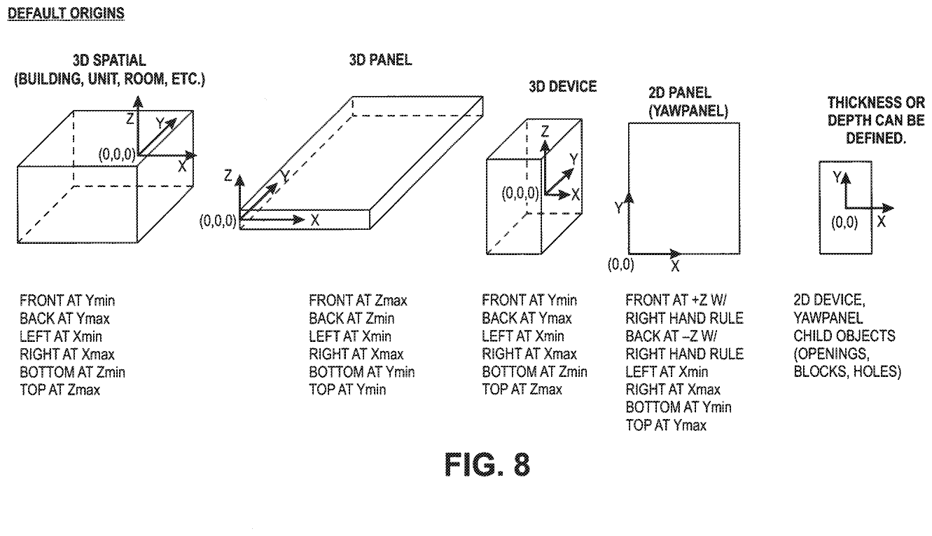

As for the mounting locations for electrical devices being specified in terms of a set of coordinates 560 on a panel in the architectural model, as illustrated in FIG. 5G, the benefit of using a common, consistent geometric system definition for data objects thereof, e.g., data objects for the 3D architectural model of the building, its ceilings, floors, walls, panels thereof, and electrical devices therein, is understood. FIG. 8 provides an example of a geometric system definition for these objects, in particular, the default origins according to a three dimensional x, y, z coordinate system. Note that an object's origins may be set differently than the default origins as long as the object's own child objects and own instances are correctly placed according to the origins. For example, the origin of a unit may be set at the load center location. Using this system, a point and/or plane of reference is provided for the front, back, left, right, bottom and top of each building, its ceilings, floors, walls, panels thereof, and electrical devices therein.

Finally, with reference to FIGS. 4A, 5A and 5F, logic 545 outputs the locations of all the electrical devices. In one embodiment the locations of all the electrical devices is set forth as a list accompanying or in a Bill of Materials (BOM) report 490, 550 that may be used, e.g., by the BIM software, to identify materials and equipment, as well as quantities and costs thereof. With reference to FIGS. 4A, 5A, and 5H, logic 545 may also prepare at least relevant portions of so-called electrical “Shop Drawings” 475, 570, identifying electrical devices 571, 572 and their respective locations 573, 574. Alternatively, such information is part of the report 465 that, in turn, is fed to CAD software 405, and used to update the Structural frame Model 411, which the BIM plug-in software incorporates into the architectural model, and from which the electrical shop drawings may be generated.

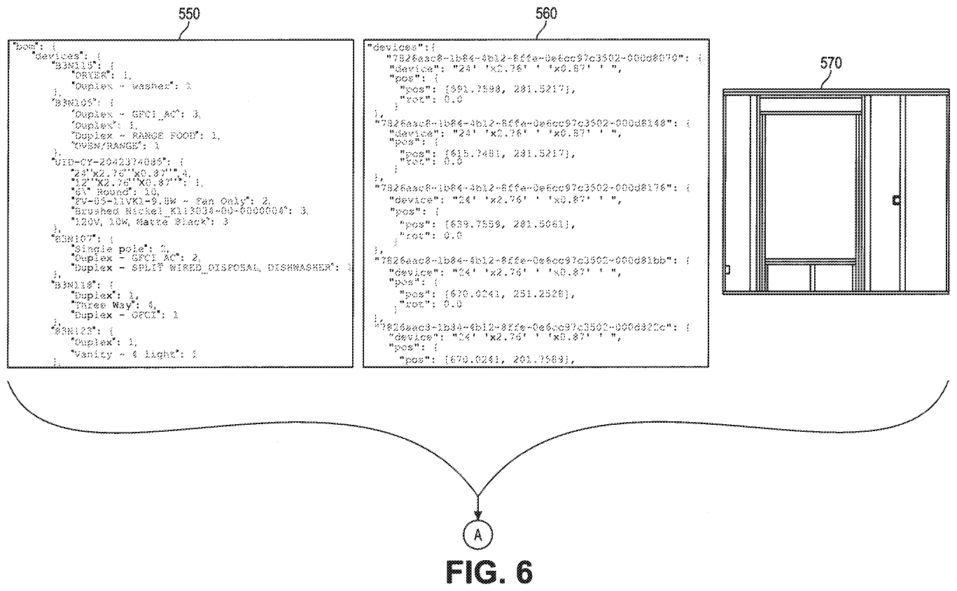

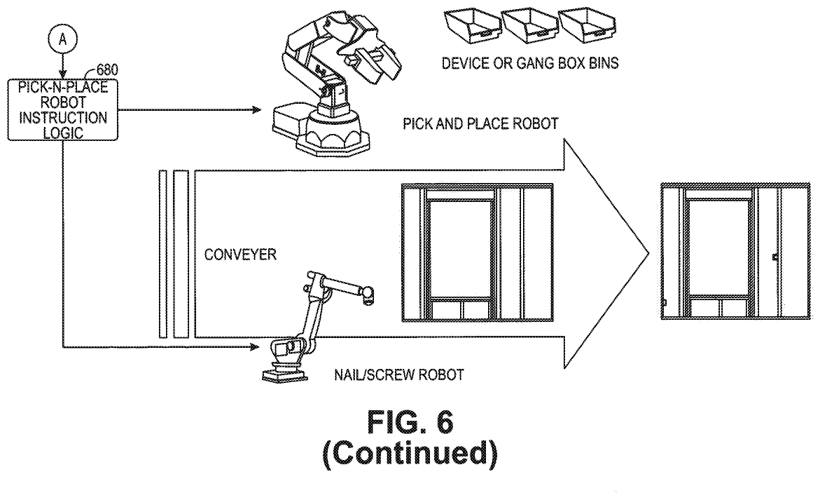

With reference to FIGS. 5A and 6, the electrical device location information 560 may be forwarded by logic 545, along with the BOM 550 and shop drawings 570, to logic 680 that controls a robotic arm to pick and place electrical devices on a wall panel under construction in a manufacturing site or location, e.g., a wall panel on a conveyor belt passing by a robotic arm. While the embodiment illustrated in FIG. 6 depicts two robotic arms, one for picking and placing electrical devices, and another for affixing with nail or screw the electrical devices to the structural framing data members of a panel, it is understood that both functions may be performed by the same robotic device. According to a different embodiment, the electrical device location information 560 may be forwarded by logic 545, along with the BOM 550 and shop drawings 570, to construction workers on a building site so that they can build the floors, walls, and ceilings of a building according to traditional on-site stick-by-stick framing and construction methods, knowing exactly where to locate the electrical devices.

### Cost-Optimized Route for an Electrical Cable in a Three-Dimensional Model of a Building

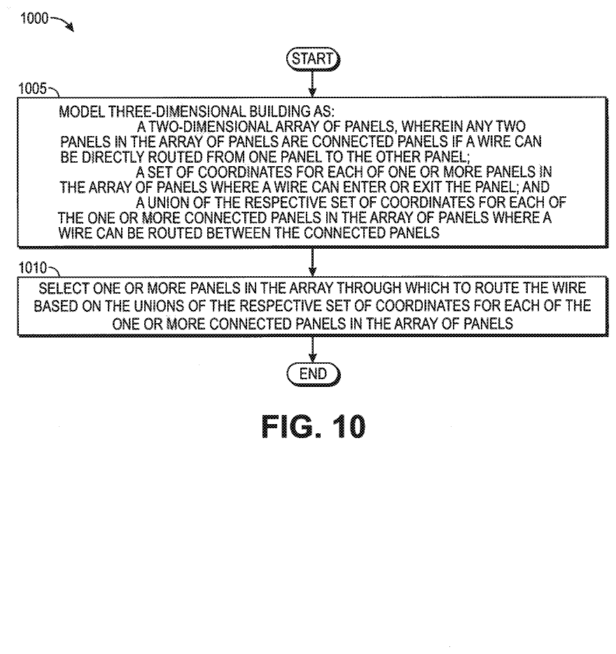

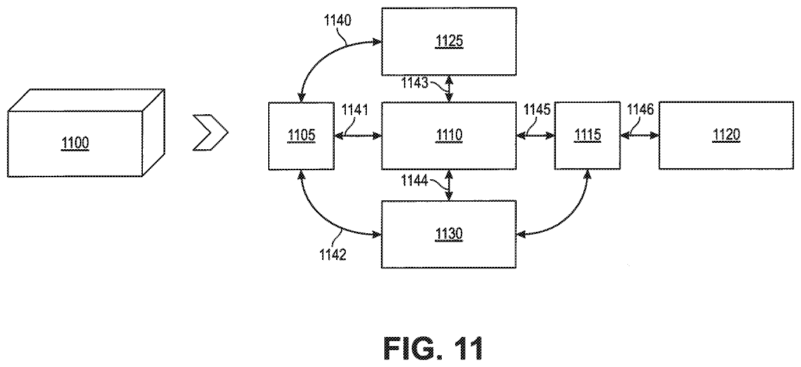

As discussed above, certain of the logic blocks as illustrated in FIG. 2, in accordance with embodiments of the invention, work together to provide a method for defining a route for a wire through a three-dimensional building, for example, a cost-optimized route, or a shortest-path route. With reference to FIG. 10, the method 1000 comprises logic 1005 for modeling the three-dimensional building as: a two-dimensional array of panels (wall, ceiling, and floor panels), wherein any two panels in the array of panels are connected panels if a wire can be directly routed from one panel to the other panel, a set of coordinates for each of one or more panels in the array of panels where a wire can enter or exit the panel, and a union of the respective set of coordinates for each of the one or more connected panels in the array of panels where a wire can be routed between the connected panels. Logic 1010 then selects one or more panels in the array through which to route the wire based on the unions of the respective set of coordinates for each of the one or more connected panels in the array of panels. Further details of this embodiment are discussed below with reference to FIGS. 11-23.

With reference to FIG. 11, a three-dimensional building 1100 may be modeled as a two-dimensional array of panels, wherein any two adjacent panels in the array of panels are “connected panels” if a wire can be directly routed from one panel to the other panel. For example, building 1100 has six panels, or sides, or faces: left (wall) panel 1105, top (ceiling) panel 1110, right (wall) panel 1115, bottom (floor) panel 1120, back (wall) panel 1125, and front (wall) panel 1130 in this simple embodiment. The embodiment models the six panels as a two-dimensional array of panels, as illustrated in FIG. 11. Some pairs of adjacent panels are considered “connected panels” in the sense that a wire can be routed directly from one panel to the other panel. The arrows 1140-1146 depict connections between two panels, in other words, the arrows depict connected panels. For example, left panel 1105 and top panel 1110 are connected panels as depicted by arrow 1141. Likewise, left panel 1105 and back panel 1125 are connected panels as depicted by arrow 1140, and left panel 1105 and front panel 1130 are connected panels as depicted by arrow 1142. Not every panel is necessarily connected to another panel, and not all adjacent panels are connected panels. For example, bottom panel 1120 is connected to right panel 1115 as depicted by arrow 1146, but even though bottom panel 1120 is adjacent to left panel 1105, back panel 1125 and front panel 1130, it is not a connected panel with any of those three panels as is indicated in FIG. 11 by the absence of an arrow between bottom panel 1120 and any one of left panel 1105, back panel 1125 and front panel 1130.

According to one embodiment, each panel is abstraction of a physical panel created by the structural framing data and optional panelization tool (e.g., CAD S/W 205, CAD S/W 405). The panel abstraction, referred to herein as a YawPanel, is a route friendly abstraction of the physical panel, meaning that all electrical routing happens within, or is mapped through, a panel according to embodiments of the invention, as described further below. Two panels, in particular, two YawPanels, are connected panels (from the perspective of routing electrical wires or cables) if or when a wire or cable can go from one panel to another panel.

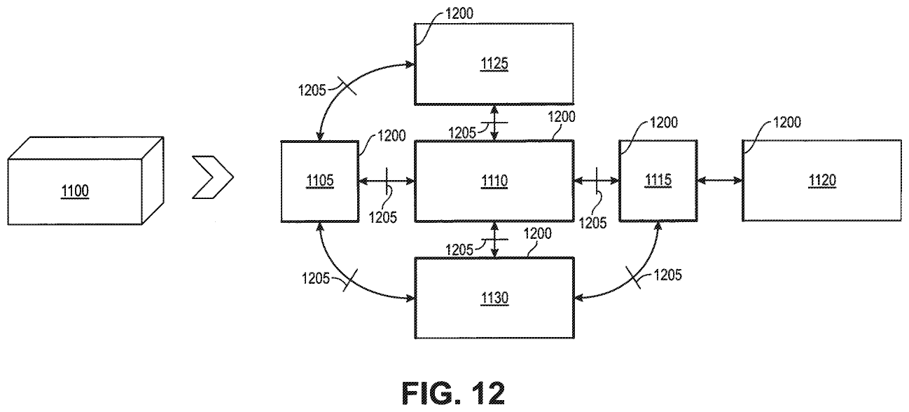

According to the embodiments, a set of coordinates, referred to herein as “panel coordinates”, or a “YawPanelEdge”, may be generated for each of one or more panels in the array of panels to identify an “edge” where a wire can enter or exit the panel. See, for example, the heavy black lines 1200 along one or more edges of the panels in FIG. 12, which depict the edges on the side of panels where a wire can enter or exit the panel.

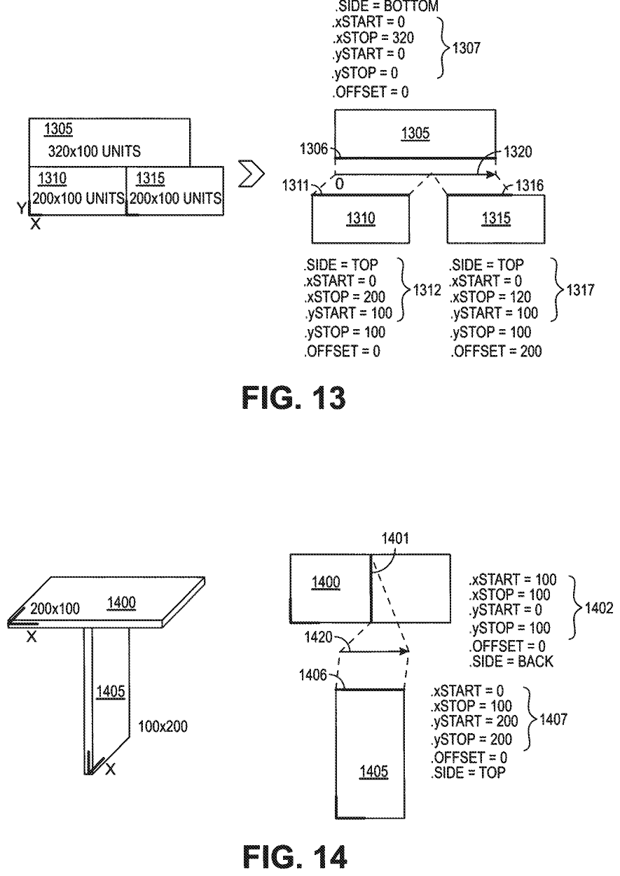

FIG. 13 illustrates an array of panels 1305, 1310 and 1315, each with a set of coordinates, or locations, at which a wire can enter or exit the panel, referred to herein as “side edges” of the panel. Side edges exist on the boundary of a panel and are of side type BOTTOM, RIGHT, LEFT, or TOP. In one embodiment, side edges are LINEAR objects. A LINEAR object identifies one row of a column of cells that is abutted to cells of another panel. A panel can have several non-overlapping side edges of the same side type. In FIG. 13, there are three panels 1305, 1310 and 1315. Panel 1305 has a length of 320 units (the unit of measure is not relevant in this example) along the X axis, and a width or height of 100 units along the Y axis. Panels 1310 and 1315 each have a length of 200 units along the X axis, and a width or height of 100 units along the Y axis.

Panels 1305 and 1310 are connected panels, as depicted by the heavy black lines 1306 and 1311, and panels 1305 and 1315 are connected panels, as depicted by the heavy black lines 1306 and 1316. The example in FIG. 13 only highlights horizontal side edges by which two panels are connected. It is appreciated that similarly, two panels may be connected by vertical side edges. The panel coordinates, or YawPanelEdge coordinates 1307, at which a wire can enter or exit panel 1305 are listed in FIG. 13 with reference to an origin of zero (0) on an X and Y axes, located in the lower left corner of the panel. In particular, the coordinates extend from X=0 to X=320 units, and from Y=0 to Y=0 (this being a horizontal bottom side edge, and not a vertical side edge). The offset for the coordinates along the X axis for this panel in the array of panels is zero. Similarly, the coordinates 1312 and 1317 for respective panels 1310 and 1315 are expressed as follows. The coordinates for panel 1310 extend from X=0 to X=200 units, and from Y=100 to Y=100 (this being a horizontal top side edge, and not a vertical side edge), with an offset of zero for the coordinates along the X axis for this panel in the array of panels. The coordinates for panel 1315 extend from X=0 to X=120 units, and from Y=100 to Y=100, from an offset of 200 for the coordinates along the X axis for this panel in the array of panels. Note the ending X coordinate (.xStop)=120, indicating the side edge of the panel at which a wire can enter or exit the panel extends only along the first 120 units of length along the top side edge of the panel, and not the entire length of the top side edge, compared to panel 1310. Further, note the offset (.offset) for the beginning of the coordinates=200.

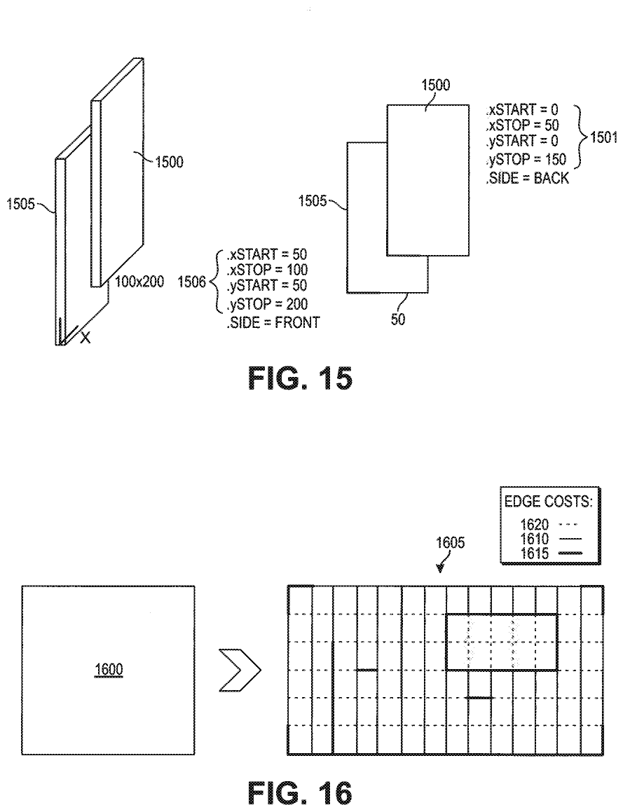

The example in FIGS. 12 and 13 demonstrate the case where the set of coordinates, or locations, at which a wire can enter or exit a panel, apply to “side edges” of the panel. However, “front edges” and “back edges” are also possible, as depicted in FIG. 14, and “area edges” are also possible, as depicted in FIG. 15. In one embodiment, area edges are AREA objects. An AREA object identifies an AREA of cells that is abutted to a similar or overlapping area of cells on another abutted panel. With reference to FIG. 14, even though YawPanels are idealized two-dimensional objects, they can be connected in three-dimensional fashion. “Front edges” and “back edges” specify such connections between two panels. Front and back side yaw panel edges can be linear (e.g., to form a “T”) or area (parallel planes). In the example illustrated in FIG. 14, panel 1400 has a back side edge 1401 and panel 1405 has a top is edge 1406, and the top side edge 1406 of panel 1405 is connected to the back side edge 1401 of panel 1400. Panel 1400 has a length of 200 units along the X axis, and a width or height of 100 units along the Y axis, while panel 1405 has a length of 100 units along the X axis, and a height of 200 units along the Y axis. The top side edge of panels 1405 abuts the back side edge of panel 1400, creating a line where wire routes can exit one panel and enter the other panel. The panel coordinates, or YawPanelEdge coordinates 1402, at which a wire can enter or exit the back side edge of panel 1400 extends from X=100 to X=100 units, and from Y=0 to Y=100. The YawPanelEdge coordinates 1407, at which a wire can enter or exit the top side edge of panel 1405 extend from X=0 to X=100 units, and from Y=200 to Y=200.

With reference to FIG. 15, “area edges” are illustrated. Panels 1500 and 1505 each has a length of 200 units along the Y axis, and a width of 100 units along the X axis. Panels 1500 and 1505 are abutted front to back, creating an area of overlap where wire routes can exit one panel and enter the other panel. These areas of overlap are connections that are modeled as “area edges”. In this particular case, the front edge of panel 1505 is connected to the back edge of panel 1500. The panel coordinates, or YawPanelEdge coordinates 1506, at which a wire can enter or exit the front area edge of panel 1505 are listed in FIG. 15 with reference to an origin of zero (0) on an X and Y axes, located in the lower left corner of the panel. In particular, the coordinates extend from X=0 to X=100 units, and from Y=50 to Y=200. The YawPanelEdge coordinates 1501, at which a wire can enter or exit the back area edge of panel 1500 extend from X=0 to X=50 units, and from Y=0 to Y=150.

With reference to FIG. 12, given the panel coordinates for a panel at which a wire can enter or exit the panel (a “YawPanelEdge”), the union or combination of those coordinates with the coordinates of an adjacent, abutting, panel at which a wire can enter or exit the adjacent panel defines (a “YawEdge”) where a wire can be routed between the two adjacent, abutting panels. Embodiments of the invention select one or more panels in the array of panels through which to route a wire based on these unions of the set of coordinates for each of the one or more connected panels in the array of panels. The lines 1205 in FIG. 12 depict the union of the panel coordinates (YawPanelEdges) for abutting panels that define where a wire can be routed between the panels. Likewise line 1320 in FIG. 13 and line 1420 in FIG. 14 depicts this union. In FIG. 15, the union (YawEdge area) is inferred.

With reference to FIG. 15, according to embodiments, each panel in the 2D array of panels is itself an abstraction of its own two-dimensional array (a YawPanel) for purposes of determining a cost-optimized path or route for a wire entering and/or exiting the panel, or connecting to an electrical device located in or on the panel. The embodiments model each panel in the two-dimensional array of panels as a two-dimensional array, or grid, of quadrilateral cells, assign a cost to each cell in the array of cells for the panel, and calculate a route for the wire through each panel based on the assigned costs of the cells in the array of cells for the panel.

According to an embodiment, the two dimensional array of quadrilateral cells is modeled to align with a structural design of a corresponding physical panel in the three-dimensional building. Further according to the embodiments, one or more panels in the array of panels is selected through which to route a wire based not only on the unions of the set of coordinates for each of the one or more connected panels in the array of panels but also based on the defined route for the wire through each panel based on the assigned costs of the cells in the array of cells for the panel.

In one embodiment, a cost is assigned to each side of each cell in the array of cells for the panel. In such an embodiment, assigning the cost to each cell in the array of cells involves assigning the cost to each cell based on the assigned cost to each side of the cell.

With reference to FIG. 16, a data model for a YawPanel is illustrated. A YawPanel is rectangular, according to embodiments of the invention. A physical panel 1600 is abstracted into a two-dimensional array of cells 1605. A minimal number of rows and columns are used to define the cells, sufficient to define the corresponding blockages from studs, beams, plates, windows, doors, etc., within the two-dimensional array of cells. Row height and/or column width may vary from panel to panel, and/or from row to row or column to column within a panel, but is consistent within each row and column of a given panel. Blockages are represented by cell edges and are assigned a cost 1610 that can vary depending on the blockage. For example, studs and beams are modeled as edge costs and can vary for each cell, depending on cell location, and the thickness of such studs and beams. Likewise, openings or blockages presented by windows and doors or other restricted areas (e.g., the header above a window or door) are modeled as cell blockages, and no transition or route through such blockage is allowed. Essentially, the cost 1615 assigned to such cells is prohibitively high, or infinite. Conversely, holes or openings from one cell to another cell are modeled at a cost 1620 of zero. Essentially, holes are modeled by removing the edge or side cost at individual cells.

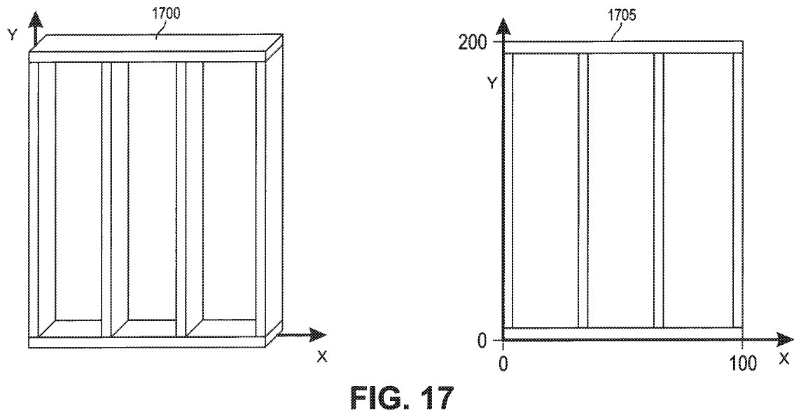

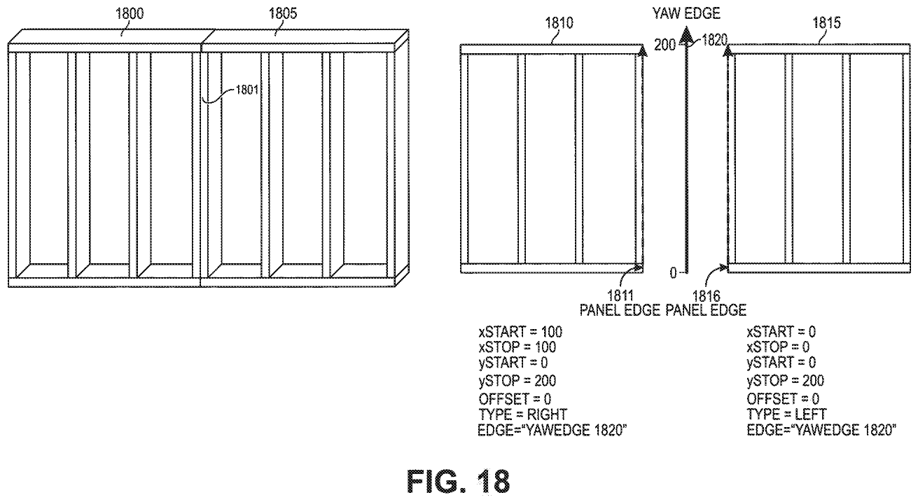

FIG. 17 illustrates a data model for a YawPanel in which a physical panel 1700, comprised of, for example, studs, beams, headers, plates, and openings that are actually three dimensional, is abstracted into a two-dimensional array of cells (YawPanel) 1705. FIG. 18 illustrates two abutting physical panels 1800 and 1805 abstracted into two abutting YawPanels 1810 and 1815. Just as the two physical panels 1800 and 1805 are physically connected along abutting edges 1801, the YawPanels 1810 and 1815 are side by side “connected panels” by virtue of the right side edge (YawPanelEdge) 1811 of YawPanel 1810 abutting left side edge (YawPanelEdge) 1816 of YawPanel 1815. The union of YawPanelEdge 1811 and 1816 is represented by YawEdge 1820, and consists of the respective coordinates of the right side edge of YawPanel 1810 and the left side edge of YawPanel 1815. In the example illustrated in FIG. 18, the coordinates for the connection at the right side edge of YawPanel 1810 are X=100 to X=100, and Y=0 to Y=200, and the coordinates for the connection at the left side edge of YawPanel 1815 are X=0 to X=0, and Y=0 to Y=200. Generally speaking, a panel can only have a left connection at xstart=xstop=0 and a right side edge connection at xstart=xstop=xdim, where xdmin is the length of the panel along the X axis.

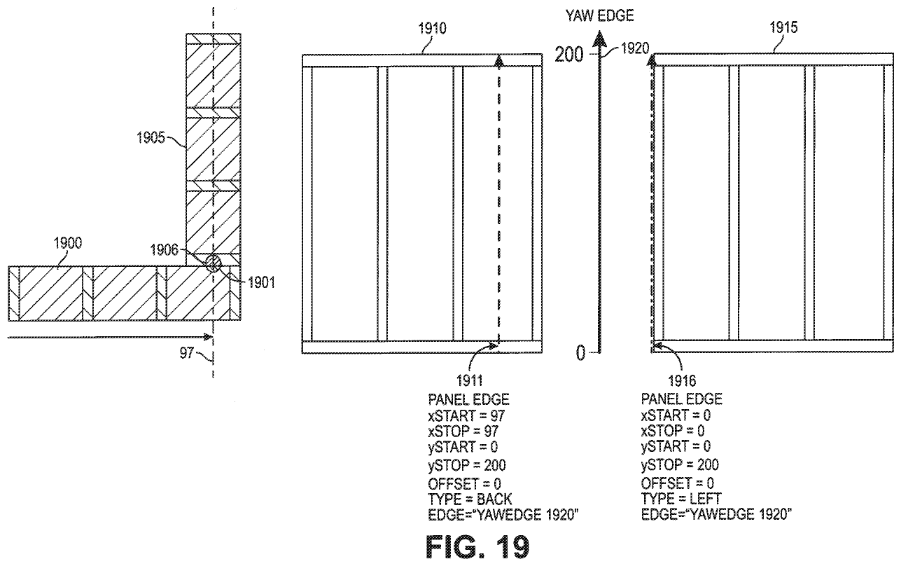

FIG. 19 illustrates two physical panels 1900 and 1905 abutting at the back 1901 of panel 1900 and the left side edge 1906 of panel 1905, abstracted into two abutting YawPanels 1910 and 1915. Just as the two physical panels 1900 and 1905 are physically connected along the back side 1901 of panel 1900 abutting next to the edge 1906 of panel 1905, the YawPanels 1910 and 1915 are side to back “connected panels” by virtue of the back edge (YawPanelEdge) 1911 of YawPanel 1910 abutting the left side edge (YawPanelEdge) 1916 of YawPanel 1915. The union of YawPanelEdge 1911 and 1916 is represented by YawEdge 1920, and consists of the respective coordinates of the back edge of YawPanel 1910 and the left side edge of YawPanel 1915. In the example illustrated in FIG. 19, the coordinates for the connection at the back edge of YawPanel 1910 are X=97 to X=97, and Y=0 to Y=200, and the coordinates for the connection at the left side edge of YawPanel 1915 are X=0 to X=0, and Y=0 to Y=200.

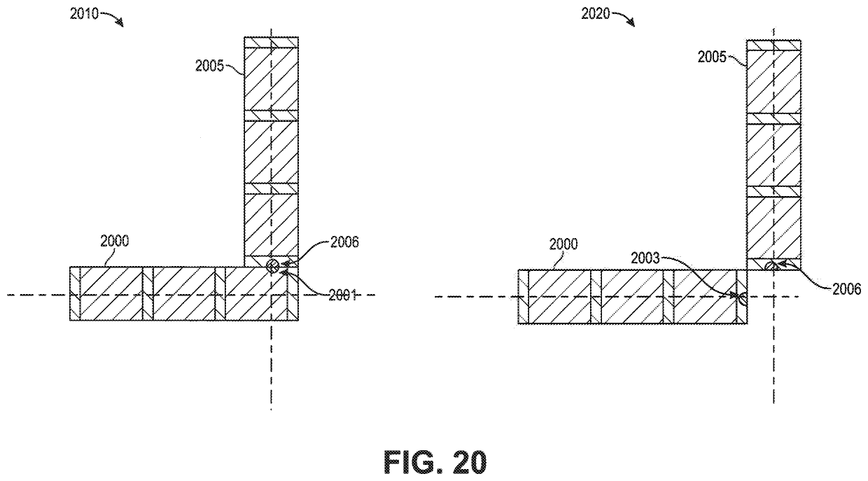

FIG. 20 illustrates vertical orthogonal physical panels 2000 and 2005 abutting side to back at 2010, where only one stud needs to be drilled, versus abutting side to side at 2020, where two studs needs to be drilled, to accommodate a wire routed from one panel to the other. In the side to back situation 2010, a wire would be routed to the left side 2006 of panel 2005 and the back side 2001 of panel 2000. In the side to side situation 2020, a wire would be routed from the left side 2006 of panel 2005 to the right side 2003 of panel 2000.

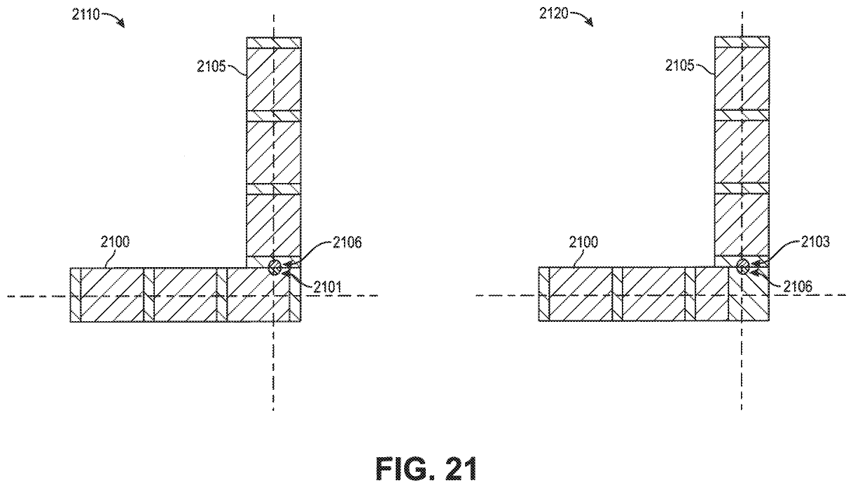

FIG. 21 further illustrates vertical orthogonal physical panels 2100 and 2105 abutting side to back at 2110, where the back YawPanelEdge 2101 of panel 2100 is between studs, so a route from panel 2100 to 2105 is possible, where only one stud needs to be drilled, versus abutting side to side at 2120, where the back YawPanelEdge 2016 is on two studs of panel 2100 that need to be drilled, in addition to the stud at the left side edge 2103 of panel 2015 that needs to be drilled, to accommodate a wire routed from one panel to the other. In the side to back situation 2110, a wire would be routed to the left side 2106 of panel 2105 and the back side 2101 of panel 2100. In the side to back situation 2020, the route for a wire from the back side 2106 of panel 2100 to the left side 2103 of panel 2105 is effectively blocked, as two holes would need to be drilled at orthogonal angles to each other, and somehow a wire routed through the resulting corner, which is too costly in terms of installing the wire to be routed between panels 2100 and 2105.

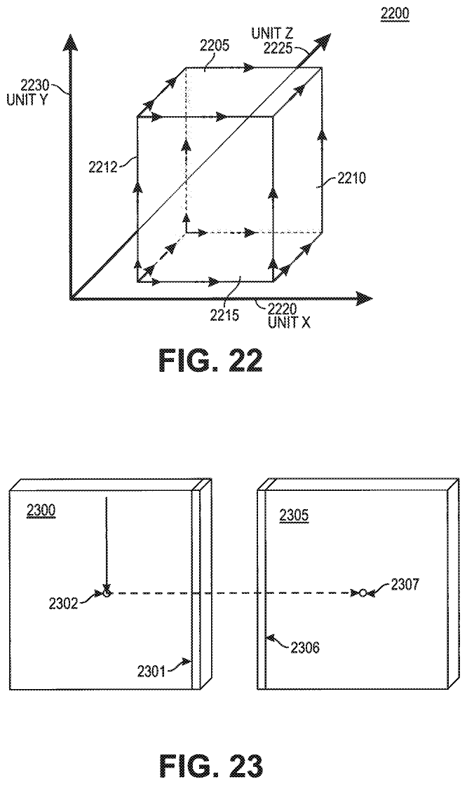

FIG. 22 illustrates at 2200 the local origin of YawPanels, according to embodiments of the invention. Recall from above the definition of a YawEdge as the union or combination of coordinates for one panel with the coordinates of an adjacent, abutting, panel at which a wire can be routed between the two adjacent, abutting panels. YawEdges have a direction and the direction of connected panel edges match. That is, when walking a YawEdge, by increasing its coordinate, the corresponding points on the connected panels should have one coordinate increase (the other is constant). As long as the direction of all unit X, or Y, or Z axis arrows is the same this constraint is met. Once the direction is set, the local origin of all panels is set.

If the panels are aligned with a unit coordinate system such as illustrated in FIG. 22, then using UnitX axis 2220 and UnitZ axis 2225 as the direction for the CeilingPanel 2205 local coordinates, using UnitX axis 2220 and UnitY axis 2230 for the direction of panels aligned with the UnitX axis 2220 (e.g., FrontPanel 2215), and choosing UnitZ axis 2225 and UnitY axis 2230 for the panels aligned with the UnitZ axis 2225 (e.g., RightPanel 2210) accomplish that. In the example illustrated in FIG. 22, the right side of FrontPanel 2215 is connected to the left side of RightPanel 2210, and the left side of the FrontPanel 2215 is connected to the left side of the LeftPanel 2212.

A cost model for optimizing cost associated with routing a wire from one cell to another cell takes into consideration such costs as: the cost of electrical wire or cabling, the cost of turning a corner with the cable, the cost of existing holes, the cost of drilling new holes, savings for using or re-using existing holes for different electrical networks, the costs of routing wire through an area (e.g., some areas can be tagged as less desirable, i.e., more costly, than other areas). Embodiments of the invention find the lowest-cost route to all cells and saves the route information for the path to relevant cells, and connect N electrical devices (as a cheapest sequence, or cheapest electrical network) using N−1 routes.

FIG. 23 illustrates one implementation of a cost model used for optimizing cost associated with routing a wire from one cell (YawCell 2300) to another cell (YawCell 2305) in the array of two-dimensional cells of a YawPanel in accordance with embodiments of the invention. Routing goes from the center 2302 of cell 2300 to the center 2307 of the other cell 2305. Within a cell there are no obstructions, or blockages, and no associated cost(s). At the edges of a cell, there may be a blockage, either a hard blockage (through which a wire cannot be routed, represented, for example, by a prohibitive or infinite cost, or by removing a cell to cell connection), or a soft blockage (through which a wire can be routed, but represented at a cost that can vary depending on the type of blockage). These blockages can occur at top, bottom, left, right, front or back of a cell. For example, cell 2300 has a soft blockage 2301 that represents a stud at the right edge of the cell, and cell 2305 has a soft blockage 2306 that represents a stud at the left edge of the cell. The total cost to route a wire from cell 2300 to cell 2305 is the sum of the costs of the soft blockages 2301 and 2305.

In general, assuming the total cost to route a wire to a first cell is known, the cost to route a wire to an adjacent, second cell to the right of the first cell is the sum of: a corner cost if the route for the wire to the first cell comes from the top or bottom of the cell (and does not come from the left side of the first cell); the wire cost (for wire to travel half the width of the first cell from the left edge to the center of the cell), the edge cost of exiting the first cell (for wire to travel half the width of the first cell, from the center of the cell to the right edge of the cell), the edge cost of entering the second cell (for wire to travel half the width of the second cell from the left edge to the center of the cell), and the body cost of the second cell.

Embodiments of the invention route a wire according to the following costs:
1. Aggregated wire cost: Embodiments model the material and labor cost of the wires (e.g., based on cost of a selected cable (obtained from a cable library) with a 35% overhead cost (per RSMeans) (obtained from a cost library));
2. Corner cost: Embodiments model extra wire and increased installation effort, mainly used to ensure the minimization of corners (e.g., fixed cost per type of cable (cost library));
3. Edge cost: Embodiments model the labor cost of drilling a hole through a stud, beam, header plate, and the like (e.g., cost per inch drilling depth (cost library));
4. Body cost: Adds a (micro) cost to identify less desirable route areas (e.g., a vertical route through a cell neighboring a stud is preferred above a cell not neighboring a stud, as the former allows the wire to be stapled to the stud);
5. Re-use Discount: A discount can be specified for the edge cost and wire cost if a (partial) path is re-used. The discount for re-using holes is significant.

According to embodiments of the invention, electrical circuit optimization can be performed, in which a complete electrical circuit is globally optimized. Embodiments of the invention may decide:
1. Which of all eligible electrical devices to connect to the load center;
2. The order in which to connect various electrical switches in each circuit, and if more than two switches, which ones to will be single pole, three-way and which ones double pole three-way; and
3. What device-to-device connections to use to connect a set of devices.

Optimization may be based on total routing cost, not just wire length or distance, in which embodiments:
1. Understand costs of adding corners internally and externally (between panels);
2. Understand costs of traversing beams and studs; and
3. Understand savings of using pre-drilled holes and re-using identified new holes.

### Detailed Route for an Electrical Cable in a Three-Dimensional Model of a Building

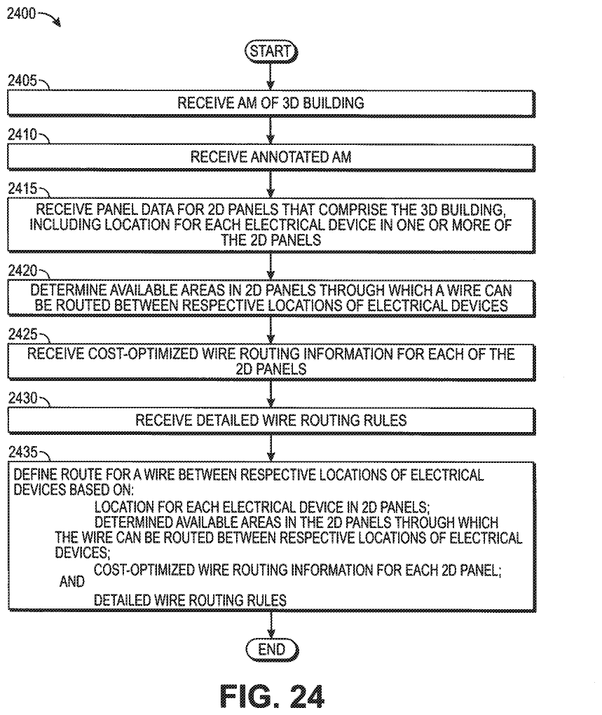

As discussed above, certain of the logic blocks as illustrated in FIG. 2, in accordance with embodiments of the invention, work together to provide a method for defining a detailed route for a wire between electrical devices in a plan for a three-dimensional (3D) building. With reference to FIG. 24, the method 2400 comprises logic 2405 for receiving an architectural model (AM) of the 3D building, and/or logic 2410 for receiving an annotated AM with structural design information, and electrical design information. Logic 2415 receives structural framing data for a plurality of two-dimensional (2D) panels that comprise the 3D building based on the annotated AM, the structural framing data comprising a location for each of a plurality of electrical devices in one or more of the plurality of 2D panels. Logic 2420 then determines available areas in one or more of the plurality of 2D panels through which a wire can be routed between respective locations of two or more of the plurality of electrical devices. Logic 2425 receives the cost-optimized wire routing information for each of the plurality of 2D panels. Logic 2430 receives detailed wire routing rules. Finally, logic 2435 defines a route for a wire between respective locations of two or more of the plurality of electrical devices in one or more of the plurality of 2D panels based on one or more of: the location for each of a plurality of electrical devices in one or more of the plurality of 2D panels; the determined available areas in one or more of the plurality of 2D panels through which the wire can be routed between respective locations of two or more of the plurality of electrical devices; the cost-optimized wire routing information for each of the plurality of 2D panels; and the detailed wire routing rules.

With reference to the functional block diagram in FIG. 4A, an embodiment of the invention 400 includes electrical details logic 440 which includes electrical cable routing logic 460 to specify an electrical wire or cable route between electrical devices in an architectural model for a three-dimensional (3D) building, and means for routing and affixing the cables to beams and studs within the panels using, e.g., staples, zip ties, etc., and exactly where on the beams or studs to affix the cables. In particular, embodiments of the invention provide a detailed three-dimensional routing of interconnection systems based on three-dimensional spaces and a determination of custom paths or routes for electrical wires or cables. As discussed further below, embodiments provide an automated process of routing electrical cables to manufacturable and installable details, including automatically generating drill holes for electrical cable runs that can be sent to a CNC machine for precise drilling, and further generating an accurate bill of materials that includes all components of electrical wiring, including electrical devices, cables, staples, zip ties, end caps, and cable stackers. Shop drawings too are generated automatically and accurately provide seamless manufacturing of Wire-In-Wall panels. Finally, installation drawings 480 are generated to make site installation of wires with clear instructions. Different embodiments provide a manual process of routing electrical cables, including automatically generating instructions for drill holes for electrical cable runs that can be sent an electrician on-site for precise drilling, and further generating an accurate bill of materials that includes all components of electrical wiring, including electrical devices, cables, staples, zip ties, end caps, and cable stackers. Shop drawings too are generated automatically and accurately provide the information needed to construct at the building site the floors, ceilings, and walls of the building, and provide for the installation of electrical devices. Finally, installation drawings are generated to make site installation of wires with clear instructions.

Embodiment 400 receive as input an architectural model 420 for a building project comprising one or more buildings. The architectural model (AM) may be created with building information modeling (BIM) software 415. In the illustrated embodiment, the BIM software does not include electrical design information. Such information is input as part of the MEP Circuit Model 421. BIM plug-in software 425 receives the MEP Circuit Model 421 as input and augments the AM to include this information. Likewise, structural design information is not present in the AM 420. Computer aided design (CAD) structural framing data and optional panelization software 405 generates an IFC data model 410 of structural framing data and optional panelization information. In one embodiment, the IFC data model 410 of the structural framing data and optional panelization data is not compatible with the BIM software and corresponding database, so the IFC data model 410 is converted into a structural frame model 411 that is compatible with the BIM software and corresponding database, and then added to the AM via the BIM plug-in software 425. In another embodiment, the IFC data model is compatible with the BIM software and database and so is input or incorporated directly into the database by BIM plug-in software 425 to augment the AM to include the structural design information.

The BIM plug-in software 425 receives the architectural model 420, the structural framing data and optional panelization information in structural frame Model 411, and the electrical design details in MEP Circuit Model 421, and generates data objects 435, such as data objects for detail route rules, cable library objects and electrical device categories (discussed above). These data objects are input to and used by the electrical details logic 440, in particular, the cable route logic 460, to route electrical cables between the electrical devices located within the panels.

Examples of detail route rules include:
1. Cable Supports
   maxSeparation: maximum allowed separation between supports;
   maxFromDevice: maximum allowed support distance from device; and
   minRollUpDiameter: minimum diameter of roll-ups.
2. Drills
   preDrillDiameter: diameter of pre-drilled holes;
   preDrillHeight: height of pre-drilled holes from bottom;
   diameter: typical diameter of custom drill holes for electrical cables;
   maxStudThickness: maximum thickness of stud that can be drilled; and
   maxStudPack: maximum number of studs in a pack or group that can be drilled.

Examples of cable library objects include:
1. Cables
2. Cable supports
3. Zip ties
4. End caps
5. Cable stackers

Embodiments of the invention receive at electrical details logic block 440 the data objects 435, including structural framing data the structural frame model 411, and further from one or more libraries, user control rules 436 and electrical code (e.g., NEC) rules 437. User control rules are control parameters that a user can input to control the electrical cable route logic 460 in terms of where to route electrical cables. For example, user rules might include allowable locations for drilling holes in beams or studs 485, and the maximum diameter and length of any such holes.

A known product number (KPN) database 430 provides corresponding part numbers for each object 435, whether the KPN for an electrical device 432, or the KPN for an electrical cable 433, and costs data for each device or cable, to the electrical details logic 440.

Electrical cable route logic 460 generates the specific routes for electrical cables between electrical devices based on the user rules and code rules, and outputs the specific electrical wiring route details 465. This information, in turn, is provided to CAD structural framing data and optional panelization software 405, wherein a CAD user can modify the Structural frame IFC data 410 to take into consideration new details regarding the actual placement, or location, of the electrical devices, and wires routed there between. The Structural frame IFC data 410, in turn, may be converted to Structural frame Model 411 data and added to the BIM by BIM plug-in 425, which updates the wiring detail and drilling model 470 for the BIM accordingly.

With reference to FIG. 25A, one embodiment 2500 for electrical cable routing logic 460 is described as follows. The process receives structural framing data model 511, location information for pre-drilling holes 2505, electrical device location information 2510, cost-optimized approximate cable routing information 2525 (generated according to the embodiments described above), and detail routing rules 2540. Logic 2515 identifies individual structural frame blockages, e.g., structural framing members of panels, such as beams, studs, plates, where an electrical cable cannot be routed, and merges adjacent structural frame blockages and electrical device placements for each panel, as depicted at 2530 (and with reference to the process described above with reference to FIG. 5D, in which respective abutting vertical studs 517, 518, 519, and 520 are merged as a structural frame blockage as a single structural frame blockage 516 for the purpose of locating an electrical device). Some or all of this information may previously have been saved at logic 505 and provided as input to logic 2515

With reference to FIGS. 5A, 5E and 25A, logic 2520 identifies additional areas, such as openings 522 (windows, doors), and restricted areas 523, 524 where an electrical cable cannot, should not, or preferably should not, be routed, such as through or under or over a window, and merges adjacent areas as single area blockage. Area blockages, in turn, as the case may be, are merged with the adjacent merged structural frame blockages. For example, with reference to FIG. 5E, structural frame blockages and area blockage are merged into one blockage 521. An electrical cable will not be routed through a blockage 521. Embodiments of the invention group, or geometrically merge, the structural frame blockages and area blockages to represent the blockages as a single blockage 521 for the purpose of routing an electrical cable, as depicted at 2535.

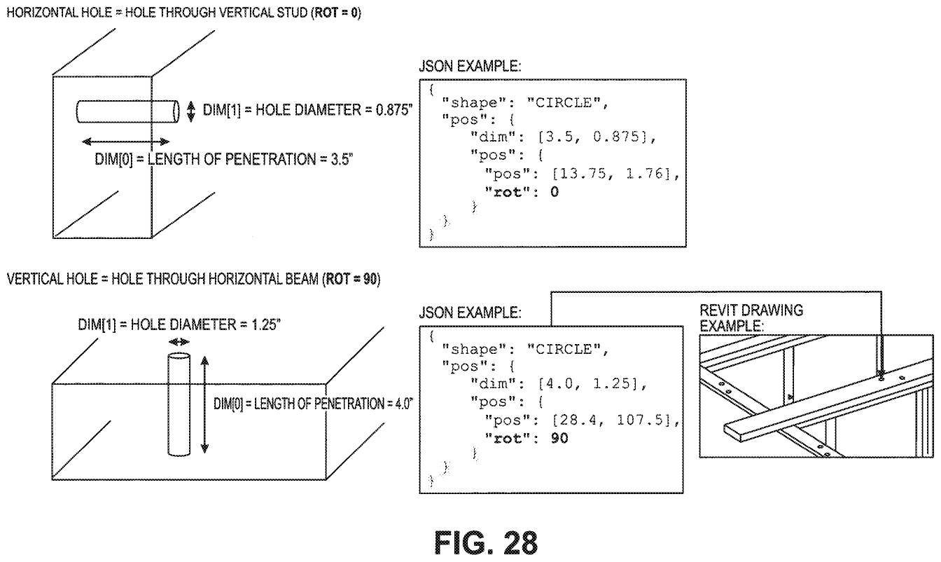

Logic 2550 then determines, based on the above inputs, a detailed route for each electrical cable, and outputs one or more of: 1) a cable and cable support Bill of Materials 2556, with reference to FIG. 25B, 2) shop drawings 2560/2561, with reference to FIG. 25C, which shows exact cable routes and even where to loop or roll-up excess cables that will be pulled through an exit of the panel to connect to an electrical device in another panel once the panels are assembled, for example, on the building site, 3) an installation drawing for each individual electrical cable 2565/2566, with reference to FIG. 25D, and 4) custom drilling instructions 2570 for a CNC machine, which, in turn, performs automatic drilling on studs with logic 2575 to provide the holes needed to route the electrical cables. FIG. 28 illustrates custom drilling instruction for CNC, as may be output at logic 2570.

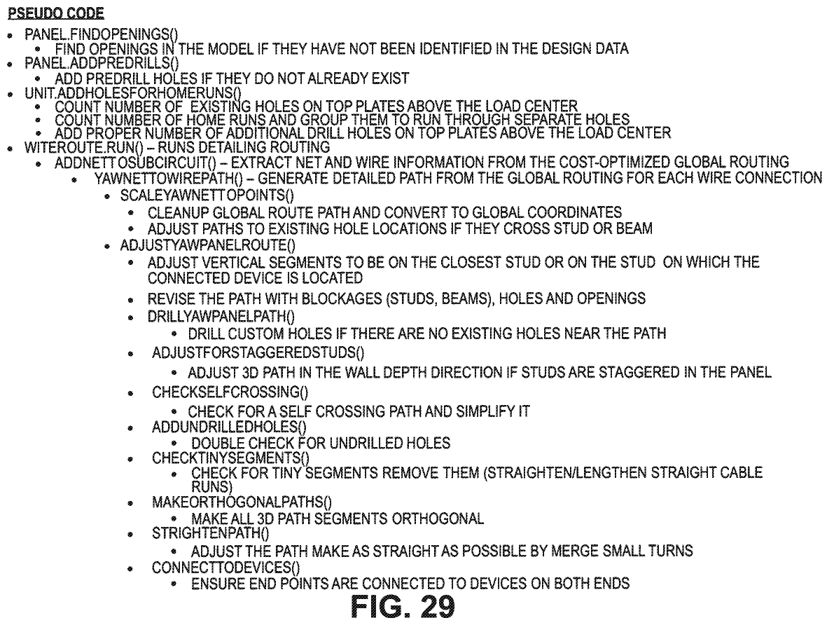

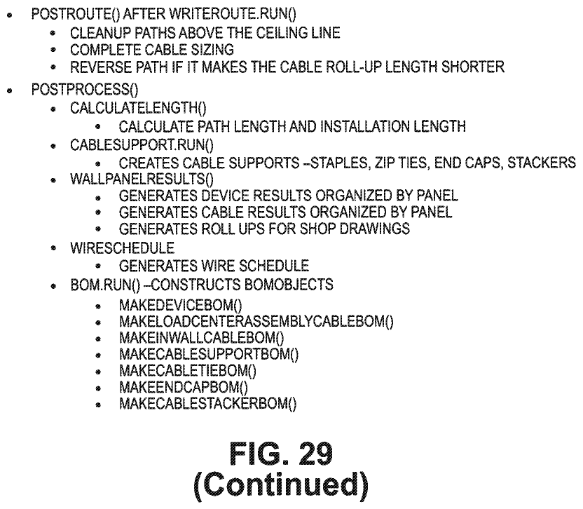

FIG. 29 provides example pseudocode for the logic described with reference to FIG. 25A.

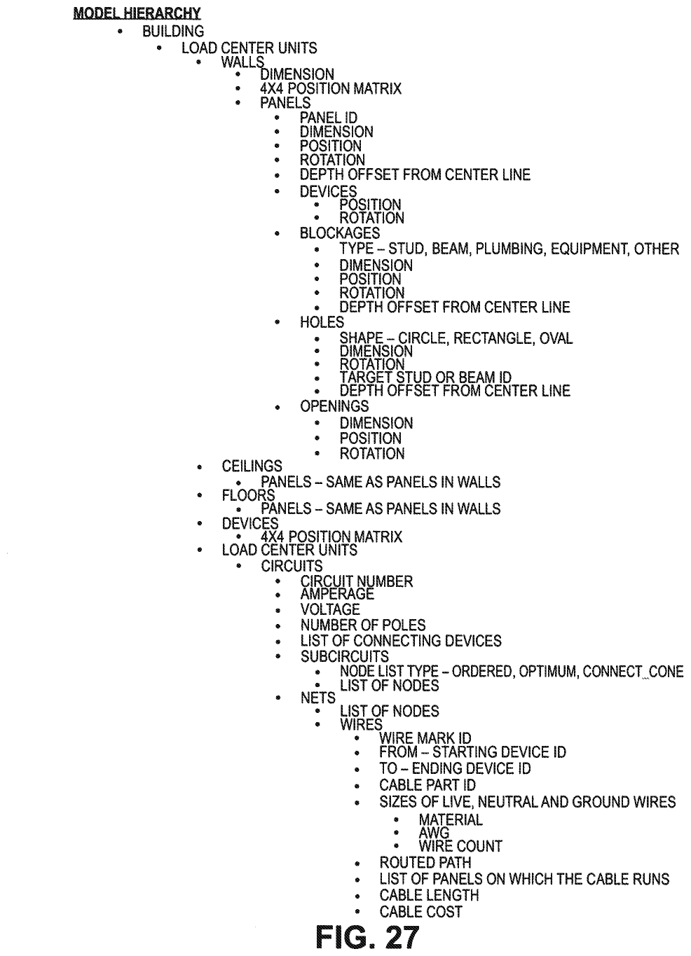

The process performed by the logic blocks described with reference to FIG. 25A provide for updating the structural framing data model 511 with significant details regarding the model. FIG. 27 illustrates a hierarchy for the model, and where within the hierarchy the information generated by the logic blocks is located, e.g., panel holes, location of load center units, electrical circuits, electrical networks (“nets”), net nodes, and wires between nodes in each net.

The Bill of Materials (BOM) report 2556 may be used, e.g., by the BIM software, to identify materials and equipment, as well as quantities and costs thereof. With reference to FIGS. 4A and 25A, logic 2555 may also prepare at least relevant portions of so-called electrical “Shop Drawings” 475, and wiring detail and drilling model information 470. Alternatively, such information is part of the report 465 that, in turn, is fed to CAD software 405, and used to update the Structural frame Model 411, which the BIM plug-in software incorporates into the architectural model, and from which the electrical shop drawings and wiring detail and drilling model may be generated.

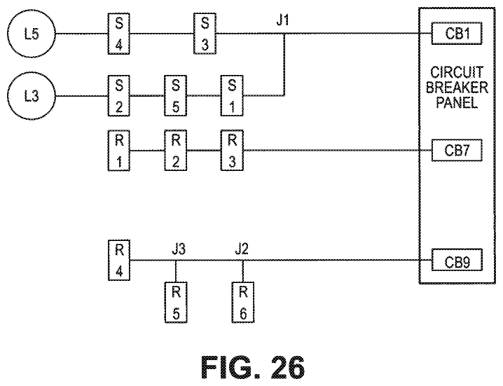

With reference to FIG. 26, the following definitions are utilized by embodiments of the invention for detailed routing logic 2550 to generate the electrical routing detail:

Unit: a set of walls/ceilings/floors that have devices that are served by a single load center. This is not necessarily a structural unit. It is an electrical unit for device placement and wire routing.

Circuit: One circuit is controlled by one breaker. See FIG. 26, in which 3 circuits—#1, #2 and #3 are controlled by CB1, CB7 and CB9, respectively as shown

Subcircuit: a list of connected devices of each branch of a circuit. Examples, with reference to FIG. 26:

Subcircuit A: [(CB1, S1), {S3, S4}, L5]

Subcircuit B: [(CB1, S3), {S1, S2, S5}, L3]

Subcircuit C: [CB7, <R1, R2, R3>]

Subcircuit D: [CB9, <R4, R5, R6>]

Nomenclature for the above:

[ ]: connects all nodes in the list in the same order as they appear

{ }: connects all nodes in the list in an optimum serial order

< >: connects to all node in the list in an optimum parallel order

( ): connects to only one of the listed nodes

Net: Optimized subcircuit device (or node) connection list determined by device locations and a subcircuit definition. Examples, with reference to FIG. 26:

Circuit #1:
If junction box allowed, Net A: [CB1, J1, S3, S4, L5], Net B: [J1, S1, S5, S2, L3]
If junction box not allowed, Net A: [CB1, S3, S4, L5], Net B: [S3, S1, S5, S2, L3]

Circuit #2, Junction is NOT allowed: Net C: [CB7, R3, R2, R1]

Circuit #3: Junction is allowed: Net D: [CB9, J2, R6], Net E: [J2, J3, R5], Net F: [J3, R4]

Wire: Physical connection between nodes among nodes in the net. Example, with reference to FIG. 26:

Net C consists of 3 wires (CB7-R3, R3-R2 and R2-R1),

Net D consists of 2 wires (CB9-J2 and J2-R6),

Net E consists of 2 wires, and

Net F consists of 1 wire (J3-R4).

Route: Physical path of a wire that connects two nodes (electrical devices)

### CONCLUSION

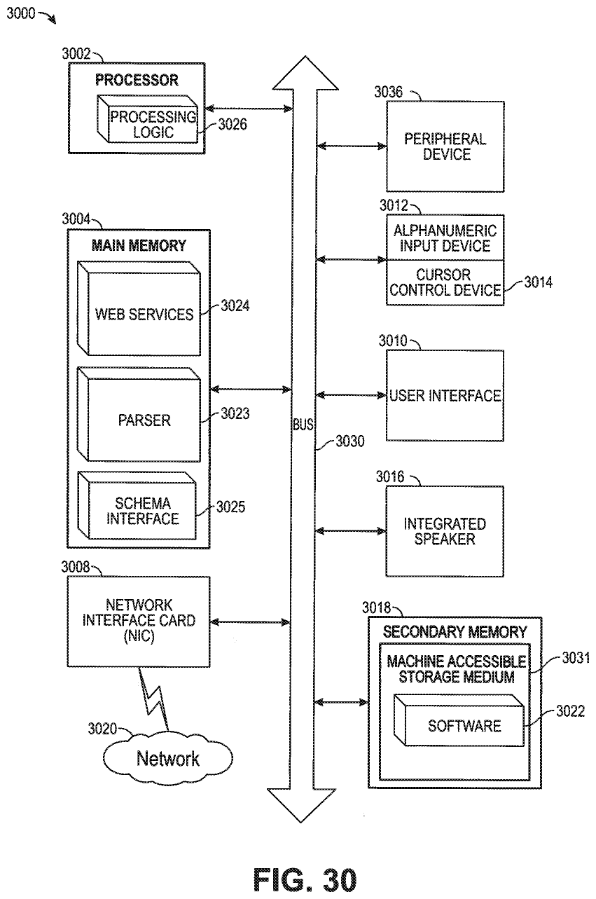

FIG. 30 illustrates a diagrammatic representation of a machine 3000 in the exemplary form of a computer system, in accordance with one embodiment, within which a set of instructions, for causing the machine 3000 to perform any one or more of the methodologies discussed herein, may be executed. In alternative embodiments, the machine may be connected, networked, interfaced, etc., with other machines in a Local Area Network (LAN), a Wide Area Network, an intranet, an extranet, or the Internet. The machine may operate in the capacity of a server or a client machine in a client-server network environment, or as a peer machine in a peer to peer (or distributed) network environment. Certain embodiments of the machine may be in the form of a personal computer (PC), a tablet PC, a set-top box (STB), a Personal Digital Assistant (PDA), a cellular telephone, a web appliance, a server, a network router, switch or bridge, computing system, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein.

The exemplary computer system 3000 includes a processor 3002, a main memory 3004 (e.g., read-only memory (ROM), flash memory, dynamic random access memory (DRAM) such as synchronous DRAM (SDRAM) or Rambus DRAM (RDRAM), etc., static memory such as flash memory, static random access memory (SRAM), etc.), and a secondary memory 3018, which communicate with each other via a bus 3030. Main memory 3004 includes information and instructions and software program components necessary for performing and executing the functions with respect to the various embodiments of the systems, methods for implementing embodiments of the invention described herein. Instructions 3023 may be stored within main memory 3004. Main memory 3004 and its sub-elements are operable in conjunction with processing logic 3026 and/or software 3022 and processor 3002 to perform the methodologies discussed herein.

Processor 3002 represents one or more general-purpose processing devices such as a microprocessor, central processing unit, or the like. More particularly, the processor 3002 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processor 3002 may also be one or more special-purpose processing devices such as an application specific integrated circuit (ASIC), a field programmable gate array (FPGA), a digital signal processor (DSP), network processor, or the like. Processor 3002 is configured to execute the processing logic 3026 for performing the operations and functionality which are discussed herein.

The computer system 3000 may further include one or more network interface cards 3008 to interface with the computer system 3000 with one or more networks 3020. The computer system 3000 also may include a user interface 3010 (such as a video display unit, a liquid crystal display (LCD), or a cathode ray tube (CRT)), an alphanumeric input device 3012 (e.g., a keyboard), a cursor control device 3014 (e.g., a mouse), and a signal generation device 3016 (e.g., an integrated speaker). The computer system 3000 may further include peripheral device 3036 (e.g., wireless or wired communication devices, memory devices, storage devices, audio processing devices, video processing devices, etc.).

The secondary memory 3018 may include a non-transitory machine-readable storage medium (or more specifically a non-transitory machine-accessible storage medium) 3031 on which is stored one or more sets of instructions (e.g., software 3022) embodying any one or more of the methodologies or functions described herein. Software 3022 may also reside, or alternatively reside within main memory 3004, and may further reside completely or at least partially within the processor 3002 during execution thereof by the computer system 3000, the main memory 3004 and the processor 3002 also constituting machine-readable storage media. The software 3022 may further be transmitted or received over a network 3020 via the network interface card 3008.

Some portions of this detailed description are presented in terms of algorithms and representations of operations on data within a computer memory. These algorithmic descriptions and representations are the means used by those skilled in the data processing arts to most effectively convey the substance of their work to others skilled in the art. An algorithm is here, and generally, conceived to be a sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from this discussion, it is appreciated that throughout the description, discussions utilizing terms such as “processing” or “computing” or “calculating” or “determining” or “displaying” or the like, refer to the action and processes of a computer system or computing platform, or similar electronic computing device(s), that manipulates and transforms data represented as physical (electronic) quantities within the computer system's registers and memories into other data similarly represented as physical quantities within the computer system memories or registers or other such information storage, transmission or display devices.

In addition to various hardware components depicted in the figures and described herein, embodiments further include various operations which are described below. The operations described in accordance with such embodiments may be performed by hardware components or may be embodied in machine-executable instructions, which may be used to cause a general-purpose or special-purpose processor programmed with the instructions to perform the operations. Alternatively, the operations may be performed by a combination of hardware and software, including software instructions that perform the operations described herein via memory and one or more processors of a computing platform.

Embodiments of invention also relate to apparatuses for performing the operations herein. Some apparatuses may be specially constructed for the required purposes, or may comprise a general purpose computer(s) selectively activated or configured by a computer program stored in the computer(s). Such a computer program may be stored in a computer readable storage medium, such as, but not limited to, any type of disk including optical disks, CD-ROMs, DVD-ROMs, and magnetic-optical disks, read-only memories (ROMs), random access memories (RAMs), EPROMs, EEPROMs, NVRAMs, magnetic or optical cards, or any type of media suitable for storing electronic instructions, and each coupled to a computer system bus.

The algorithms presented herein are not inherently related to any particular computer or other apparatus. Various general purpose systems may be used with programs in accordance with the teachings herein, or it may prove convenient to construct more specialized apparatus to perform the required methods. The structure for a variety of these systems appears from the description herein. In addition, embodiments of the invention are not described with reference to any particular programming language. It will be appreciated that a variety of programming languages may be used to implement the embodiments of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices, etc.

Although the invention has been described and illustrated in the foregoing illustrative embodiments, it is understood that the present disclosure has been made only by way of example, and that numerous changes in the details of implementation of the invention can be made without departing from the spirit and scope of the invention, which is only limited by the claims that follow. Features of the disclosed embodiments can be combined and rearranged in various ways.

What is claimed is:

1. A method for defining a route for a wire between electrical devices in an architectural model (AM) for a three-dimensional (3D) building, the method comprising:
receiving structural framing data for a plurality of two-dimensional (2D) panels that comprise the 3D building based on the AM, the structural framing data comprising a location for each of a plurality of electrical devices in one or more of the plurality of 2D panels;
determining available areas in one or more of the plurality of 2D panels through which a wire can be routed between respective locations of two or more of the plurality of electrical devices;
receiving wire routing rules;
defining a route for a wire between respective locations of two or more of the plurality of electrical devices in one or more of the plurality of 2D panels based on:
the location for each of a plurality of electrical devices in one or more of the plurality of 2D panels;
the determined available areas in one or more of the plurality of 2D panels through which the wire can be routed between respective locations of two or more of the plurality of electrical devices; and
the received wire routing rules.

2. The method of claim 1, wherein receiving wire routing rules comprises:
receiving wire routing information for each of the plurality of 2D panels; and
receiving detailed wire routing rules; and
wherein defining the route for the wire between respective locations of two or more of the plurality of electrical devices in one or more of the plurality of 2D panels based on the received wire routing rules comprises defining the route for the wire between respective locations of two or more of the plurality of electrical devices in one or more of the plurality of 2D panels based on the received wire routing information for each of the plurality of 2D panels, and the received detailed wire routing rules

3. The method of claim 2, wherein receiving wire routing information for each of the plurality of 2D panels comprises receiving cost-optimized wire routing information for each of the plurality of 2D panels; and
wherein defining the route for the wire between respective locations of two or more of the plurality of electrical devices in one or more of the plurality of 2D panels based on the received wire routing information for each of the plurality of 2D panels comprises defining the route for the wire between respective locations of two or more of the plurality of electrical devices in one or more of the plurality of 2D panels based on the received cost-optimized wire routing information for each of the plurality of 2D panels.

4. The method of claim 1, further comprising:
receiving the architectural model (AM) of the 3D building, the AM comprising structural design information, and electrical design information.

5. The method of claim 1, wherein determining the available areas in one or more of the plurality of 2D panels through which the wire can be routed between respective locations of two or more of the plurality of electrical devices comprises:
determining structural framing data and area blockages or restrictions in each panel; and
determining an unblocked or unrestricted space for the wire.

6. The method of claim 5, wherein determining the available areas in one or more of the plurality of 2D panels through which the wire can be routed between respective locations of two or more of the plurality of electrical devices further comprises identifying a nearest structural framing data member or stud, and a set of coordinates thereon, at which to affix the wire.

7. The method of claim 1, wherein determining the available areas in one or more of the plurality of 2D panels through which the wire can be routed between respective locations of two or more of the plurality of electrical devices comprises determining the available areas in one or more of the plurality of 2D panels through which the wire can be routed between respective locations of two or more of the plurality of electrical devices that results in a shortest or most cost-effective path for the wire.

8. Non-transitory computer readable storage media having instructions stored thereon that, when executed by a processor of a system, the instructions cause the system to perform operations for defining a route for a wire between electrical devices in an architectural model (AM) for a three-dimensional (3D) building, the method comprising:
receiving structural framing data for a plurality of two-dimensional (2D) panels that comprise the 3D building based on the AM, the structural framing data comprising a location for each of a plurality of electrical devices in one or more of the plurality of 2D panels;
determining available areas in one or more of the plurality of 2D panels through which a wire can be routed between respective locations of two or more of the plurality of electrical devices;
receiving wire routing rules;
defining a route for a wire between respective locations of two or more of the plurality of electrical devices in one or more of the plurality of 2D panels based on:
the location for each of a plurality of electrical devices in one or more of the plurality of 2D panels;
the determined available areas in one or more of the plurality of 2D panels through which the wire can be routed between respective locations of two or more of the plurality of electrical devices; and
the received wire routing rules.

9. The non-transitory computer readable storage media of claim 8, wherein receiving wire routing rules comprises:
receiving wire routing information for each of the plurality of 2D panels; and
receiving detailed wire routing rules; and
wherein defining the route for the wire between respective locations of two or more of the plurality of electrical devices in one or more of the plurality of 2D panels based on the received wire routing rules comprises defining the route for the wire between respective locations of two or more of the plurality of electrical devices in one or more of the plurality of 2D panels based on the received wire routing information for each of the plurality of 2D panels, and the received detailed wire routing rules

10. The non-transitory computer readable storage media of claim 9, wherein receiving wire routing information for each of the plurality of 2D panels comprises receiving cost-optimized wire routing information for each of the plurality of 2D panels; and
wherein defining the route for the wire between respective locations of two or more of the plurality of electrical devices in one or more of the plurality of 2D panels based on the received wire routing information for each of the plurality of 2D panels comprises defining the route for the wire between respective locations of two or more of the plurality of electrical devices in one or more of the plurality of 2D panels based on the received cost-optimized wire routing information for each of the plurality of 2D panels.

11. The non-transitory computer readable storage media of claim 8, further comprising:
receiving the architectural model (AM) of the 3D building, the AM comprising structural design information, and electrical design information.

12. The non-transitory computer readable storage media of claim 8, wherein determining the available areas in one or more of the plurality of 2D panels through which the wire can be routed between respective locations of two or more of the plurality of electrical devices comprises:
determining structural framing data and area blockages or restrictions in each panel; and
determining an unblocked or unrestricted space for the wire.

13. The non-transitory computer readable storage media of claim 12, wherein determining the available areas in one or more of the plurality of 2D panels through which the wire can be routed between respective locations of two or more of the plurality of electrical devices further comprises identifying a nearest structural framing data member or stud, and a set of coordinates thereon, at which to affix the wire.

14. The non-transitory computer readable storage media of claim 13, wherein determining the available areas in one or more of the plurality of 2D panels through which the wire can be routed between respective locations of two or more of the plurality of electrical devices comprises determining the available areas in one or more of the plurality of 2D panels through which the wire can be routed between respective locations of two or more of the plurality of electrical devices that results in a shortest or most cost-effective path for the wire.
